(19) United States
(12) Patent Application Publication
(10) Pub. No.: US 2026/0032256 A1
(43) Pub. Date: Jan. 29, 2026

(54) VIDEO PROCESSING

(71) Applicant: TENCENT TECHNOLOGY (SHENZHEN) COMPANY LIMITED, Shenzhen (CN)

(72) Inventor: Yingbin WANG, Shenzhen (CN)

(73) Assignee: TENCENT TECHNOLOGY (SHENZHEN) COMPANY LIMITED, Shenzhen (CN)

(21) Appl. No.: 19/347,597

(22) Filed: Oct. 1, 2025

Related U.S. Application Data
(63) Continuation of application No. PCT/CN2024/108799, filed on Jul. 31, 2024.

(30) Foreign Application Priority Data
Aug. 10, 2023 (CN) 202311010490.9

(51) Int. Cl. H04N 19/137; H04N 19/159; H04N 19/176; H04N 19/186

(52) U.S. Cl. CPC H04N 19/137; H04N 19/159; H04N 19/176; H04N 19/186

(57) ABSTRACT

Some aspects of the disclosure provide a method of video processing. In some examples, a current chrominance block in a current picture carried in a video bitstream being coded in a chrominance block copy intra prediction mode is determined. The chrominance block copy intra prediction mode can predict at least a value of the current chrominance block based on a displacement vector. A target displacement vector of a co-located luminance block of the current chrominance block is obtained. The target displacement vector is selected from a plurality of candidate displacement vectors associated with the co-located luminance block of the current chrominance block. At least a predicted value of the current chrominance block is determined based on the target displacement vector. The current picture that includes the current chrominance block is reconstructed based on at least the predicted value. Apparatus and non-transitory computer-readable storage medium counterpart embodiments are also contemplated.

### RELATED APPLICATIONS

The present application is a continuation of International Application No. PCT/CN2024/108799, filed on Jul. 31, 2024, which claims priority to Chinese Patent Application No. 202311010490.9, filed on Aug. 10, 2023. The entire disclosures of the prior applications are hereby incorporated by reference.

### FIELD OF THE TECHNOLOGY

This application relates to the field of audio and video technologies, including the field of video coding technologies, such as a video processing method, a video processing apparatus, a computer device, a computer-readable storage medium, and a computer program product.

### BACKGROUND OF THE DISCLOSURE

In a related video coding technology, original video data can be partitioned into a series of coding units (CUs) by using a block-based hybrid coding framework, to achieve video data compression in combination with video coding methods such as prediction, transform, and entropy coding. Currently, according to mainstream video coding standards, for example, audio video coding standard 3 (AVS3), a luminance block and a chrominance block are allowed to be separately encoded. However, it is found in practice that if inconsistent partition structures are used for a chrominance block and a luminance block of a current coding unit, an intra motion compensation technology cannot be used for the chrominance block, leading to low coding efficiency.

### SUMMARY

Embodiments of this disclosure provide a video processing method and a related device, to determine a predicted value of a chrominance block by using a displacement vector of a luminance co-located block (also referred to as co-located luminance block), so that coding performance is improved.

Some aspects of the disclosure provide a method of video processing. In some examples, a current chrominance block in a current picture carried in a video bitstream being coded in a chrominance block copy intra prediction mode is determined. The chrominance block copy intra prediction mode can predict at least a value of the current chrominance block based on a displacement vector. A target displacement vector of a co-located luminance block of the current chrominance block is obtained. The target displacement vector is selected from a plurality of candidate displacement vectors associated with the co-located luminance block of the current chrominance block. At least a predicted value of the current chrominance block is determined based on the target displacement vector. The current picture that includes the current chrominance block is reconstructed based on at least the predicted value.

Some aspects of the disclosure provide an apparatus that includes processing circuitry configured to perform the method of video processing.

Some aspects of the disclosure also provide a non-transitory computer-readable storage medium storing instructions which when executed by at least one processor cause the at least one processor to perform the method of video processing.

Some aspects of the disclosure provide another method of video processing. In some examples, to code a current chrominance block in a video by using a chrominance block copy intra prediction mode that predicts at least a value of the current chrominance block based on a displacement vector is determined. A target displacement vector of a co-located luminance block of the current chrominance block is obtained. The target displacement vector is selected from a plurality of candidate displacement vectors associated with the co-located luminance block of the current chrominance block. At least a predicted value of the current chrominance block is determined based on the target displacement vector. The video is encoded based on at least the predicted value of the current chrominance block to generate a video bitstream.

Some aspects of the disclosure provide an apparatus that includes processing circuitry configured to perform the other method of video processing.

Some aspects of the disclosure also provide a non-transitory computer-readable storage medium storing instructions which when executed by at least one processor cause the at least one processor to perform the other method of video processing.

According to an aspect, an embodiment of this disclosure provides a video processing method, including: determining a current chrominance block in a video bitstream, a chrominance block copy intra prediction mode being used for the current chrominance block; obtaining a target displacement vector of a luminance co-located block corresponding to the current chrominance block; determining a predicted value of the current chrominance block based on the target displacement vector, the predicted value being configured for reconstructing a decoded picture corresponding to the current chrominance block.

According to an aspect, an embodiment of this disclosure provides a video processing method, including: determining a current chrominance block in a video, a chrominance block copy intra prediction mode being used for the current chrominance block; obtaining a target displacement vector of a luminance co-located block corresponding to the current chrominance block; determining a predicted value of the current chrominance block based on the target displacement vector, the predicted value being configured for reconstructing a decoded picture corresponding to the current chrominance block; and encoding the video based on the predicted value of the current chrominance block to generate a video bitstream.

According to an aspect, an embodiment of this disclosure provides a video processing apparatus. The apparatus includes: a determining unit, configured to determine a current chrominance block in a video bitstream, a chrominance block copy intra prediction mode being used for the current chrominance block; and a processing unit, configured to obtain a target displacement vector of a luminance co-located block corresponding to the current chrominance block, the processing unit being further configured to determine a predicted value of the current chrominance block based on the target displacement vector. The predicted value is configured for reconstructing a decoded picture corresponding to the current chrominance block.

According to an aspect, an embodiment of this disclosure provides a video processing apparatus. The apparatus includes: a determining unit, configured to determine a current chrominance block in a video, a chrominance block copy intra prediction mode being used for the current chrominance block; and a processing unit, configured to obtain a target displacement vector of a luminance co-located block corresponding to the current chrominance block, the processing unit being further configured to determine a predicted value of the current chrominance block based on the target displacement vector. The predicted value is configured for reconstructing a decoded picture corresponding to the current chrominance block. The processing unit is further configured to encode the video based on the predicted value of the current chrominance block to generate a video bitstream.

According to an aspect, an embodiment of this disclosure provides a computer device. The computer device includes a memory and a processor. The memory has a computer program stored thereon. When the computer program is executed by the processor, the processor is enabled to perform the foregoing video processing method.

According to an aspect, an embodiment of this disclosure provides a computer-readable storage medium. The computer-readable storage medium has a computer program stored thereon. When the computer program is read and executed by a processor of a computer device, the computer device is enabled to perform the foregoing video processing method.

According to an aspect, an embodiment of this disclosure provides a computer program product or a computer program. The computer program product or the computer program includes computer instructions stored in a computer-readable storage medium. A processor of a computer device reads the computer instructions from the computer-readable storage medium, and the processor executes the computer instructions, so that the computer device performs the foregoing video processing method.

In this embodiment of this disclosure, a current chrominance block in a video bitstream may be determined, a chrominance block copy intra prediction mode being used for the current chrominance block. A target displacement vector of a luminance co-located block corresponding to the current chrominance block is obtained. A predicted value of the current chrominance block is determined based on the target displacement vector. The predicted value is configured for reconstructing a decoded picture corresponding to the current chrominance block. In view of the above, during decoding of the video bitstream, when it is determined that the chrominance block copy intra prediction mode is used for the current chrominance block, the predicted value of the current chrominance block can be determined by using the displacement vector information of the luminance co-located block, without needing to perform intra prediction processing on the current chrominance block, so that encoding/decoding efficiency of the current chrominance block is improved, thereby effectively improving coding performance.

### BRIEF DESCRIPTION OF THE DRAWINGS

FIG. 1 is a basic working flowchart of a video coder according to an embodiment of this disclosure.

FIG. 2 is a schematic diagram of inter prediction according to an embodiment of this disclosure.

FIG. 3a is a schematic diagram of establishment of a spatial list according to an embodiment of this disclosure.

FIG. 3b is a schematic diagram of establishment of a temporal list according to an embodiment of this disclosure.

FIG. 4a is a schematic flowchart of intra block copy prediction according to an embodiment of this disclosure.

FIG. 4b is a schematic flowchart of intra string copy prediction according to an embodiment of this disclosure.

FIG. 4c is a schematic flowchart of an intra string copy prediction non-ordinary string sub-mode according to an embodiment of this disclosure.

FIG. 4d is a schematic diagram of an ordinary luminance intra prediction mode according to an embodiment of this disclosure.

FIG. 4e is a schematic flowchart of template matching according to an embodiment of this disclosure.

FIG. 4f is a schematic diagram of a video sampling method according to an embodiment of this disclosure.

FIG. 4g is a schematic diagram of a structure of basic block partition according to an embodiment of this disclosure.

FIG. 4h is a schematic diagram of positions during chrominance block copy intra prediction according to an embodiment of this disclosure.

FIG. 4i is a schematic diagram of positions of fractional-pixel sample points according to an embodiment of this disclosure.

FIG. 5 is a schematic diagram of a structure of a video processing system according to an embodiment of this disclosure.

FIG. 6 is a schematic flowchart of a video processing method according to an embodiment of this disclosure.

FIG. 7a is a schematic flowchart of determination of a luminance co-located block according to an embodiment of this disclosure.

FIG. 7b is a schematic diagram of sorting of displacement vectors according to an embodiment of this disclosure.

FIG. 8 is a schematic flowchart of another video processing method according to an embodiment of this disclosure.

FIG. 9 is a schematic diagram of a structure of a video processing apparatus according to an embodiment of this disclosure.

FIG. 10 is a schematic diagram of a structure of another video processing apparatus according to an embodiment of this disclosure.

FIG. 11 is a schematic diagram of a structure of a computer device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Technical terms in this disclosure are described below.

### I. Video Coding

A video may include one or more video frames, and each video frame includes part of video signals of the video. A video signal may be acquired in two manners: either by being captured through a camera or by being generated by a computer. Because different acquisition manners lead to different statistical characteristics, video compression and coding schemes may also be different.

In mainstream video coding technologies, such as high efficiency video coding (HEVC/H.265), versatile video coding (VVC/H.266), and audio video coding standard 3 (AVS3), a hybrid coding framework is used. Based on the hybrid coding framework, a series of operations and processing are allowed to be performed on a video:
1. Block partition structure: An inputted current frame (that is, a video frame that is being encoded or decoded) may be partitioned into several non-overlapping processing units based on a size of the current frame, and each processing unit is to undergo similar compression operations. This processing unit is referred to as a coding tree unit (CTU) or a largest coding unit (LCU). The CTU may be further partitioned into smaller units to obtain one or more basic coding elements called coding units (CUs) or coding blocks. A block is a structure obtained by partitioning a picture. During encoding, the block structure may include: a coding block, a coding unit, a coding tree unit, a coding sub-block, and a super-block. Similarly, during decoding, the block structure may include: a decoding block, a decoding unit, a decoding tree unit, a decoding sub-block, and a super block. Each CU is a most basic element in a coding process. Subsequent embodiments of this disclosure describe various encoding/decoding procedures that may be used for each CU.
2. Predictive coding: Includes modes such as intra prediction and inter prediction. Prediction is performed on an original video signal included in a current CU in a current frame (that is, a CU that is being encoded or decoded in the current frame) by using a reconstructed video signal in a selected reference CU to obtain a residual video signal. The current CU may also be referred to as a current block. A video frame in which the current block is located is referred to as a current frame. A reference CU used during prediction of the current block may also be referred to as a reference block of the current block. A video frame in which the reference block is located is referred to as a reference frame. An encoder side needs to select a most suitable predictive coding mode for the current CU from a plurality of possible predictive coding modes, and informs a decoder side. The predictive coding mode may include:
a. Intra (picture) prediction: The reconstructed video signal used during prediction is from a region that has been encoded and reconstructed in the same video frame. In other words, the current block and the reference block are located in the same video frame. A basic idea of intra prediction is to eliminate spatial redundancy based on correlation between neighboring pixels in the same video frame. In video coding, the neighboring pixels are reconstructed pixels of encoded CUs around the current CU in the same video frame.
b. Inter (picture) Prediction: The reconstructed video signal used during prediction is from another encoded video frame different from the current frame. In other words, the current block and the reference block are located in different video frames.
3. Transform & quantization: The residual video signal may be converted into a transform domain through a transform operation such as discrete Fourier transform (DFT) or discrete cosine transform (DCT), and the converted signal is referred to as a transform coefficient. The residual video signal in transform domain further undergoes a lossy quantization operation, and specific information is discarded, to facilitate compression representation of a quantized signal.

In some video coding standards, there may be more than one transform manner that can be selected. Therefore, the encoder side also needs to select one of the transform manners for the current CU, and inform the decoder side. Fineness of the quantization generally depends on a quantization parameter (QP). A larger QP indicates that coefficients with a larger value range are to be quantized into a same output. This generally causes greater distortion and a lower bit rate. On the contrary, a smaller QP indicates that coefficients within a smaller value range are to be quantized into a same output. This generally causes less distortion and a corresponding higher bit rate.
4. Entropy coding or statistical coding: Statistical compression coding is performed on a quantized transform-domain signal based on occurrence frequencies of values, to finally output a binarized (0 or 1) video bitstream. In addition, other information, such as a selected predictive coding mode and a motion vector, is generated during coding. The other information also needs to undergo entropy coding to reduce the bit rate. Statistical coding is a lossless coding scheme that can effectively reduce the bit rate required for representing the same signal. Common statistical coding schemes include variable length coding (VLC) or content adaptive binary arithmetic coding (CABAC).
5. Loop filtering: Operations of inverse quantization, inverse transform, and predictive compensation (reverse operations of the foregoing 2 to 4) are performed on a CU that has been encoded, to reconstruct a decoded picture corresponding to the CU. In comparison with a raw picture, in the reconstructed picture, some information may be different from that in the raw picture because of effects of quantization, leading to distortion. Therefore, a filter may be used to perform a filtering operation on the reconstructed decoded picture, to effectively mitigate distortion caused by quantization. The filter may be, for example, a deblocking filter, a sample adaptive offset (SAO) filter, or an adaptive loop filter (ALF). Because these reconstructed decoded pictures that have undergone filtering are used as reference CUs of other CUs that need to be encoded subsequently, and are used in prediction processes of the other CUs, the foregoing filtering operation is also referred to as loop filtering and a filtering operation in a coding loop.

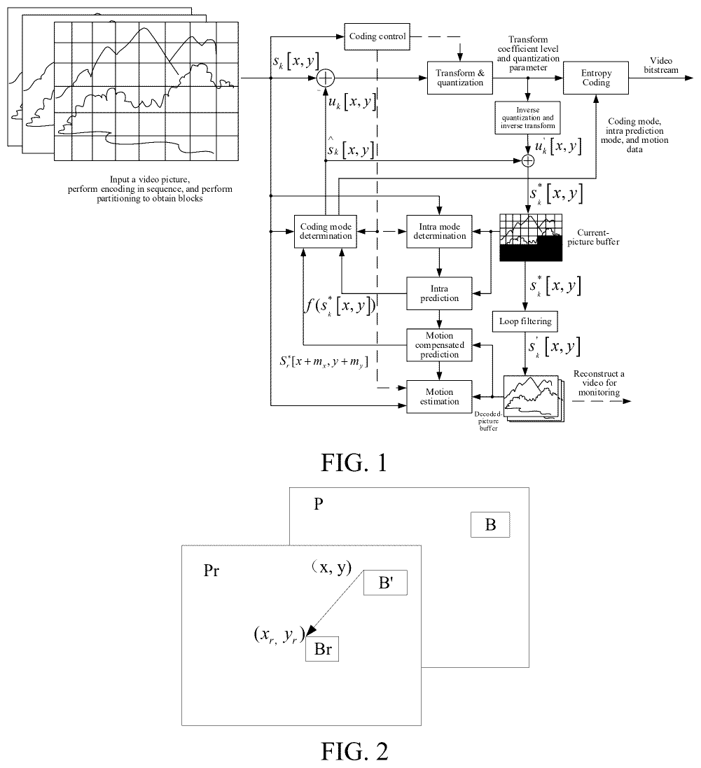

Based on related descriptions of the foregoing operations 1 to 5, an embodiment of this disclosure provides a basic working flowchart of a video coder. FIG. 1 is a basic working flowchart of a video coder according to an embodiment of this disclosure. In FIG. 1, an example in which a current block is a k^{th} CU (sₖ[x, y] as shown in FIG. 1) in a current frame (a current picture) is used for description, where k is a positive integer, and k is less than or equal to a total quantity of CUs included in the current frame. sₖ[x, y] represents a pixel point with coordinates of [x, y] in the k^{th} CU, where x represents a horizontal coordinate of the pixel, and y represents a vertical coordinate of the pixel. A predicted signal may be obtained by performing processing such as motion compensation or intra prediction on sₖ[x, y]. The predicted signal ŝₖ[x, y] is subtracted from the original signal sₖ[x, y] to obtain a residual video signal uₖ[x, y]. Then the residual video signal uₖ[x, y] is transformed and quantized. Data outputted from quantization processing may be delivered to two different procedures, A and B.
A: The data outputted from quantization processing may be delivered to an entropy coder for entropy coding, to obtain an encoded bitstream (that is, a video bitstream), and the bitstream is outputted to a buffer for storage, waiting to be transmitted out.
B: Inverse quantization and inverse transform may be performed on the data outputted from quantization processing, to obtain an inversely transformed residual video signal u′ₖ[x, y]. Next, the inversely transformed residual video signal u′ₖ[x, y] is added to a predicted signal ŝₖ[x, y] to obtain a new predicted signal s*ₖ[x, y], and the new predicted signal s*ₖ[x, y] is transmitted to a buffer of the current picture for storage. Then, intra prediction may be performed on the new predicted signal s*ₖ[x,y] to obtain f(s*ₖ[x,y]). Loop filtering may be performed on the new predicted signal s*ₖ[x, y] to obtain a reconstructed signal s′ₖ[x, y], and the reconstructed signal s′ₖ[x, y] is transmitted to a decoded-picture buffer for storage, to generate a reconstructed video. Motion compensation prediction is performed on the reconstructed signal s′ₖ[x, y] to obtain s*ᵣ[x+mₓ, y+m_{y}], where s*ᵣ[x+mₓ, y+m_{y}] may represent a reference block, mₓ and m_{y} respectively represent horizontal and vertical components of a motion vector of the reference block.

In some embodiments, a block-based hybrid coding framework is used in mainstream video coding standards such as HEVC, VVC, and AVS3. Original video data may be partitioned into a series of coding blocks, and compression of video data is implemented based on video coding methods such as prediction, transformation, and entropy coding. Motion compensation is a common prediction method used in video coding. In respect of the motion compensation, a predicted value of a current block is derived from an encoded reference block based on a temporal or spatial redundancy characteristic of video content. The prediction method includes: inter prediction, intra block copy prediction, intra string copy prediction, and the like. During a specific coding implementation, these prediction methods may be used alone or in combination. For a coding block using these prediction methods, one or more two-dimensional displacement vectors generally need to be explicitly or implicitly encoded in a video bitstream. The displacement vector indicates a displacement of a current block (or a co-located block of the current block) relative to one or more reference blocks of the current block.

A displacement vector may be given different names depending on different prediction modes and different implementations, and is described in this specification in the following manner for consistency. (i) A displacement vector in inter prediction is referred to as a motion vector (MV for short). (ii) A displacement vector in intra block copy prediction is referred to as a block vector (BV for short). (iii) A displacement vector in intra string copy prediction is referred to as a string vector (SV for short).

The following describes some related technologies in this disclosure.

### (1) Inter Prediction

The inter prediction means to utilize correlation in video time domain to predict a pixel of a current picture by using a pixel of an adjacent encoded picture, to effectively remove video time domain redundancy and effectively reduce bits for coding residual data. FIG. 2 is a schematic diagram of inter prediction according to an embodiment of this disclosure. In FIG. 2, P is a current frame, Pr is a reference frame, B is a current block, and Br is a reference block of B. A coordinate position of B′ is the same as that of B in the picture (in other words, B′ is a co-located block of B), coordinates of Br are (xr, yr), and coordinates of B′ are (x, y). A displacement between the current block and the reference block of the current block is referred to as a monitor vector (MV). In other words, MV=(xᵣ−X, yᵣ−y).

Considering that temporally or spatially neighboring blocks have strong correlation, an MV prediction technology may be used to further reduce bits needed for coding the MV. In H.265/HEVC, inter prediction includes two MV prediction modes: a merge mode and an advanced motion vector prediction (AMVP) mode. The merge mode and the AMVP mode are respectively described in detail below.
(i) Merge mode: An MV candidate list is established for a current prediction unit (PU), where there may be five candidate MVs (and reference pictures corresponding to the candidate MVs). The five candidate MVs are traversed, to select an MV with a lowest rate-distortion cost as an optimal MV. If a codec establishes a candidate list in the same manner, an encoder only needs to transmit an index of the optimal MV in the candidate list. In the MV prediction technology of HEVC, there is a skip mode, which is a special case of the merge mode. After the optimal MV is found in the merge mode, if a current block and a reference block are basically the same, there is no need to transmit residual data, and only an index of the MV and a skip flag need to be transmitted.

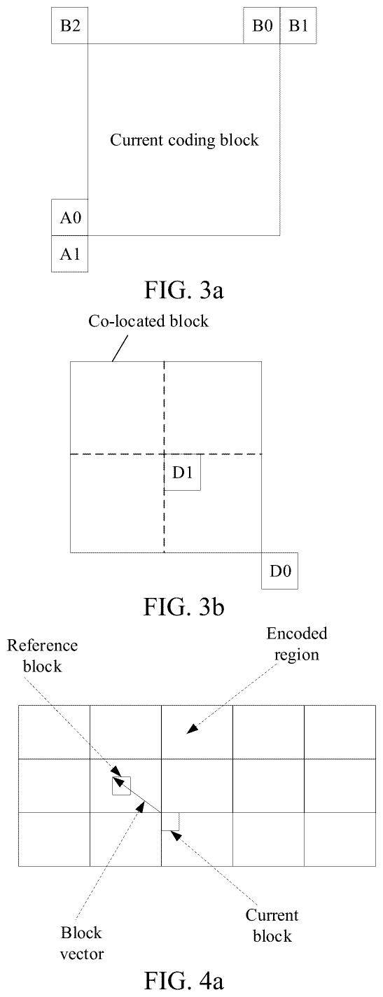

The MV candidate list established in the merge mode includes both spatial and temporal candidate lists, and further includes a combined list for a B Slice. The spatial list provides four candidate MVs at most. Establishment of the spatial list is shown in FIG. 3a. FIG. 3a is a schematic diagram of establishment of a spatial list according to an embodiment of this disclosure. The spatial list is established in an order A1→B1→B0→A0→(B2), where B2 is substitution, to be specific, when one or more of A1, B1, B0, and A0 do not exist, motion information of B2 needs to be used. The temporal list provides only one candidate MV at most. Establishment of the temporal list is shown in FIG. 3b. FIG. 3b is a schematic diagram of establishment of a temporal list according to an embodiment of this disclosure. An MV of a current PU may be obtained by scaling an MV of a co-located PU according to the following equation:

curMV=td*colMV/tb Equation (1)

In the foregoing equation (1), curMV and colMV respectively represent an MV of a current PU and an MV of a co-located PU, and td and tb respectively represent a distance between a current picture and a reference picture of the current picture and a distance between a co-located picture and a reference picture of the co-located picture. if a PU at a position D0 on the co-located block is unavailable, the PU is replaced with a co-located PU at a position D1. For a PU in a B Slice, because there are two MVs, an MV candidate list of the PU also needs to provide two motion vector predictions (MVPs). In HEVC, first four candidate MVs in the MV candidate list are pairwise combined to generate a combination list for the B Slice
(ii) AMVP mode: An MV candidate list is established for a current PU based on MV correlation between temporally or spatially neighboring blocks. Unlike in the merge mode, in the AMVP mode, an optimal predicted MV is selected from the established MV candidate list, and then differential coding is performed using an optimal MV obtained through motion search for a current block to be encoded, to obtain MVD=MV−MVP. A decoder side establishes the same MV candidate list, and only needs sequence numbers (or indexes) of an MVD and an MVP in the MV candidate list to calculate an MV of a current decoding block. The AMVP candidate MV list also includes both spatial and temporal candidate lists. A difference is that a length of the AMVP list is 2.

An HMVP is a newly used MV prediction technology in the H.266/VVC. The HMVP is a motion vector prediction method based on historical information. A motion vector MV of a historical coding block is stored in an HMVP list, and is used as an MVP of a current CU. In the H.266/VVC, the HMVP is added to the merge-mode MV candidate list, and is behind spatial and temporal MVPs. In the HMVP technology, the motion vector MV of the historical coding block is stored by using a first-in-first-out (FIFO) queue. If a stored candidate MV is the same as an MV that has just been encoded, this repeated candidate MV is to be removed, all candidate MVs in the HMVP are moved forward, and the MV of a current coding unit CU is added at a tail of the FIFO queue. If an MV of a current coding unit is different from any candidate MV in the FIFO queue, a latest MV is added to a tail of the FIFO queue. When a new MV is added to the HMVP list, if the current HMVP list has reached a maximum length, the 1st candidate MV in the FIFO queue is deleted, and then a latest MV is added to the tail of the FIFO queue. When there is a new CTU row, the HMVP list is reset (cleared). In the H.266/VVC, a size S of the HMVP list is set to 6. To reduce a quantity of redundancy check operations, the following simplification approaches are introduced:
(i) A quantity of candidates in the HMVP list for generating a merge list is set to (N<=4)?M:(8−N). N represents a quantity of existing candidate MVs in the merge list, and M represents a quantity of HMVP candidate MVs available in the list.
(ii) Once a length of the available merge list reaches a maximum allowed length minus 1, a process of constructing the HMVP merge candidate list terminates.

### (2) Intra Block Copy Prediction

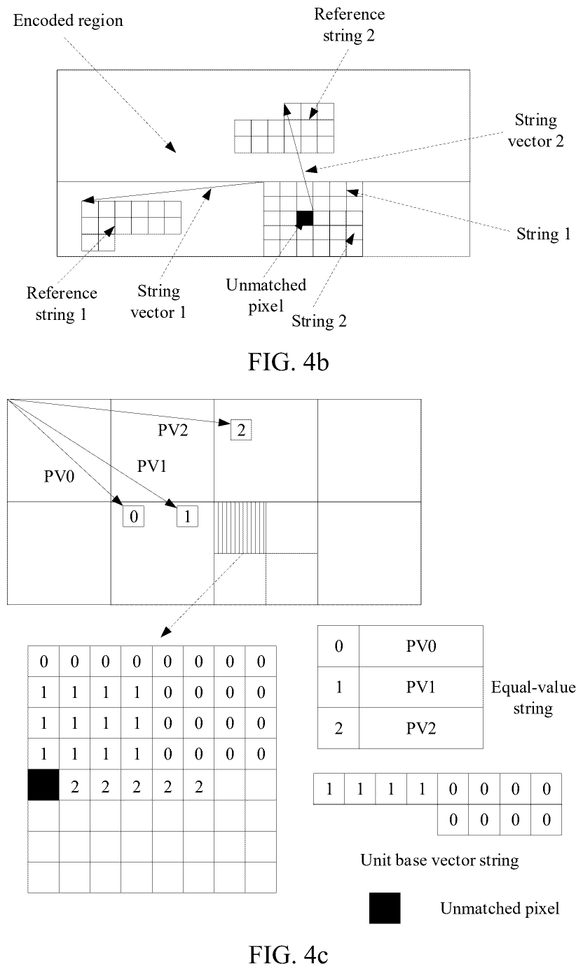

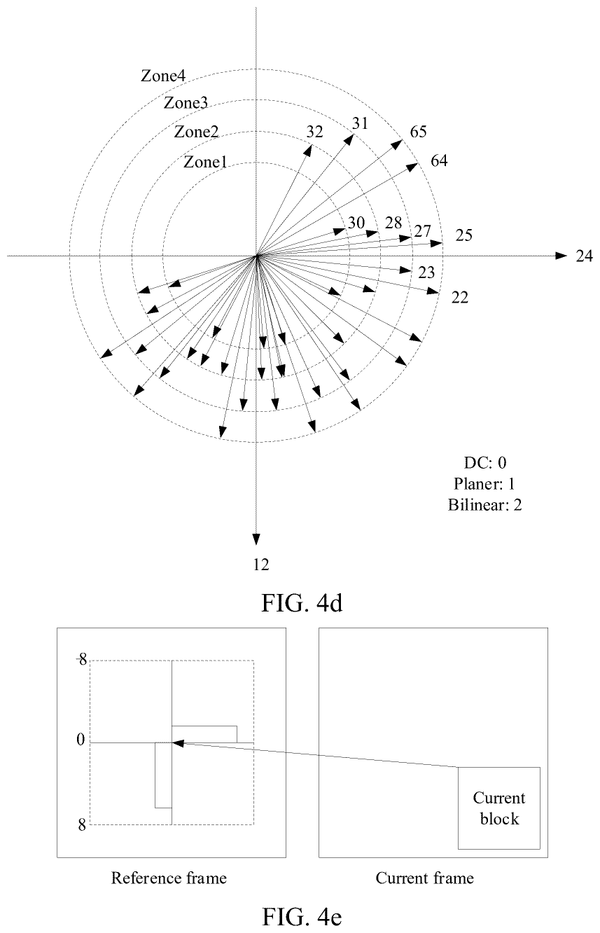

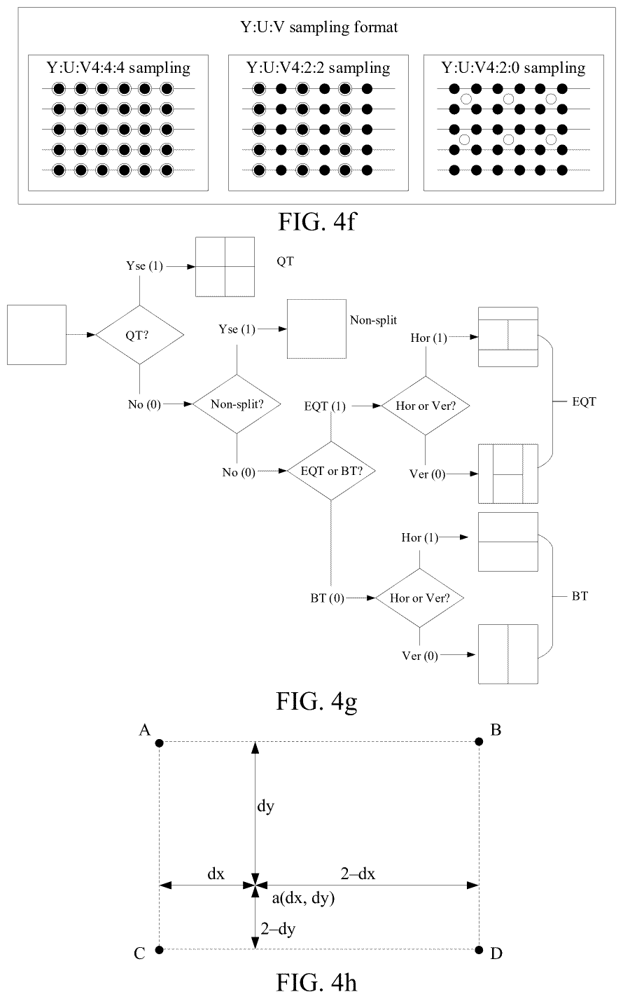

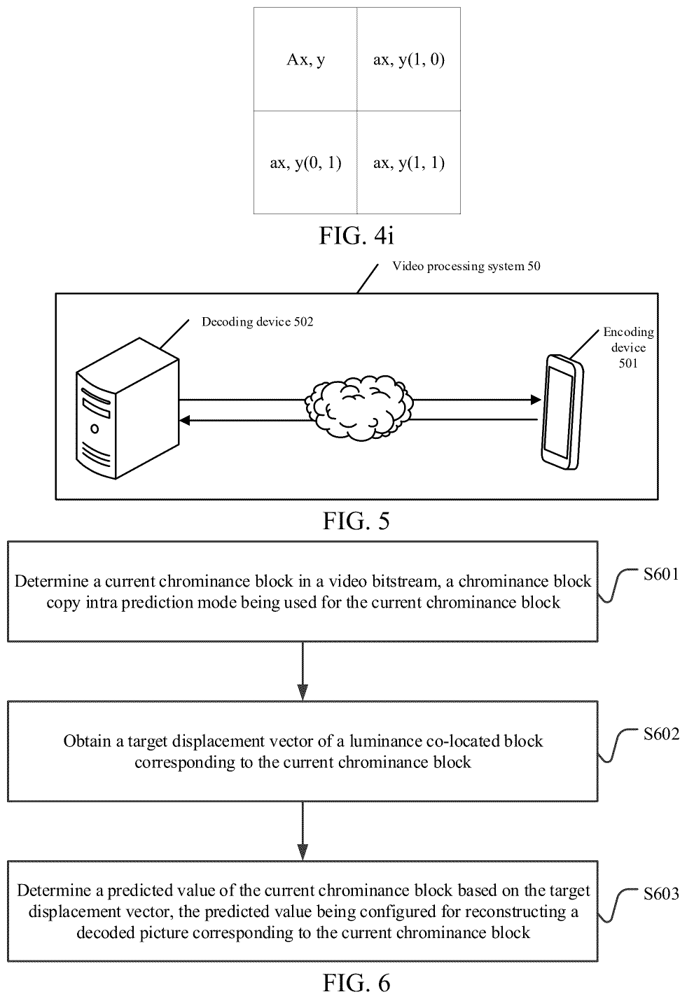

(i) Intra block copy (IBC) is an intra coding tool used in HEVC screen content coding (SCC) extension, and significantly improves efficiency of screen content coding. In AVS3 and VVC, the IBC technology is also used for improving performance of screen content coding, and the technology is referred to as an intra block copy prediction technology in AVS3. The IBC utilizes the spatial correlation of a screen content video and uses a pixel value of an encoded coding block in a current picture to predict a pixel value of a current coding block, without encoding a block vector difference (BVD) of the current coding block, to effectively reduce bits needed for coding pixels. FIG. 4a is a schematic flowchart of intra block copy prediction according to an embodiment of this disclosure. As shown in FIG. 4a, a displacement between a current block and a reference block of the current block (that is, a displacement between coordinates of an upper left corner position of the current block and coordinates of an upper left corner position of the reference block) in an IBC is referred to as a block vector (BV). The reference block is a coding block that has been encoded. Therefore, the reference block is located in an encoded region. In the H.266/VVC, a BV prediction technology similar to the inter prediction is used, to further reduce bits needed for coding a BV.
(ii) Determination of validity of intra block copy prediction

In the AVS3 standard, a reference block pointed to by a block vector obtained by decoding a video bitstream conforming to the AVS3 standard is to be limited to a range of a current largest coding unit or left N (where N is a positive integer) largest coding units. All reference samples of the reference block are to belong to a same slice as samples of the current block, and have been completely reconstructed. A value of N is as follows:

N=(1<<((7−LcuSizeInBit)<<1))−(LcuSizeInBit<7?1:0)

It is assumed that coordinates of an upper left corner position of the current block are (xCur, yCur), coordinates of an upper left corner position of a luminance component of the reference block are (xRefTL, yRefTL), and coordinates of a lower right corner position of the luminance component of the reference block are (xRefBR, yRefBR). The coordinates (xRefTL, yRefTL) and (xRefBR, yRefBR) are to satisfy the following conditions:

vSize=(LcuSize>=64)?64: LcuSize
xRefTL/vSize==xRefBR/vSize
yRefTL/vSize==yRefBR/vSize

When the upper left corner of the reference block pointed to by the block vector falls within a left neighboring largest coding unit, and a size of the largest coding unit is 128*128, an upper left corner of a 64*64 region, in which a position of the reference block's upper left corner after shifting 128 pixels to the right falls, has not been reconstructed yet, and the coordinates (xCur, yCur) need to satisfy the following conditions:

xCur!=((xRefTL+128)/64)*64
yCur!=(yRefTL/64)*64

### (3) Intra String Copy Prediction

(i) An intra string copy (ISC) technology is to partition a coding block into a series of pixel strings or unmatched pixels according to a scanning order (raster scanning, round-trip scanning, Zig-Zag scanning, or the like). In AVS3, an ISC prediction mode may include: a string copy intra prediction ordinary string sub-mode, and a string copy intra prediction non-ordinary string sub-mode. Similar to the IBC, a reference string of the same shape as each string is found in an encoded region of a current picture, to derive a predicted value of a current string based on the reference string. To encode a string vector difference (SVD) between a pixel value of the current string and the predicted value, instead of to directly encode a pixel value of the string can effectively reduce the quantity of bits required. FIG. 4b is a schematic flowchart of intra string copy prediction according to an embodiment of this disclosure. As shown in FIG. 4b, a string including 14 pixels is a current to-be-encoded string 1, a reference string 1 of the same shape as the current to-be-encoded string 1 (that is, also including 14 pixels) may be determined in the encoded region. Therefore, a displacement between the current to-be-encoded string 1 and the reference string 1 may be referred to as a string vector 1. Similarly, a string including 15 pixels is a current to-be-encoded string 2, a reference string 2 of the same shape as the current to-be-encoded string 2 (that is, also including 15 pixels) may be determined in the encoded region. Therefore, a displacement between the current to-be-encoded string 2 and the reference string 2 may be referred to as a string vector 2. In addition, one black pixel indicates an unmatched pixel.

In the intra string copy prediction technology, a string vector (SV), a string length, a matching string identifier, and the like corresponding to each string in the current block need to be encoded. The string vector (SV) represents a displacement from a current string to a reference string of the current string. The string length indicates a quantity of pixels included in the current string. The matching string identifier indicates whether a coding string matching the current string exists. If a value of the matching string identifier is 1, the coding string matching the current string exists. If a value of the matching string identifier is 0, the coding string matching the current string does not exist.
(ii) Reference range limit for the intra string copy prediction

In the AVS3 standard, any reference pixel in a reference string pointed to by a string vector obtained by decoding a video bitstream conforming to the AVS3 standard or a common position pointed by a point vector needs to be limited to a range of a current largest coding unit or left N largest coding units. A value of N is as follows:

N=(1<<((7−LcuSizeInBit)<<1))−(LcuSizeInBit<7?1:0)

IscSubtypeFlag indicates a type of the current string, a value of 0 indicates an ordinary string, and a value of 1 indicates a non-ordinary string. If a value of IscSubtypeFlag is equal to 0, the current string is an ordinary string. It is assumed that coordinates of an upper left corner position of the current block are (xCur, yCur), and coordinates of positions of any luminance component A and B of the reference string are respectively (xRefA, yRefA) and (xRefB, yRefB). The coordinates (xRefA, yRefA) and (xRefB, yRefB) need to satisfy the following conditions:

vSize=(LcuSize>=64?64:LcuSize)
xRefA/vSize==xRefB/vSize
yRefA/vSize==yRefB/vSize

If the value of IscSubtypeFlag is equal to 0, and when any luminance component A of the reference string falls within a left neighboring largest coding unit, and a size of the largest coding unit is 128*128, an upper left corner of a 64*64 region, in which a position of the luminance component A after shifting 128 pixels to the right falls, has not been reconstructed yet, and the coordinates (xCur, yCur) need to satisfy the following conditions:

xCur!=((xRefA+128)/64)*64
yCur!=(yRefA/64)*64

If the value of IscSubtypeFlag is equal to 0, all reference samples in the reference string of the current string are to be in the same slice as a sample in the current string, and have been completely reconstructed. If a value of a Y component of the string vector is greater than or equal to 0, any reference pixel in the reference string pointed to by the string vector is not to be located in the current string.

If the value of IscSubtypeFlag is equal to 1, it is assumed that coordinates of an upper left corner position of the current block are (xCur, yCur), and coordinates of a position of a luminance component A at a common position are (xRef, yRef). The coordinates (xCur, yCur) and (xRef, yRef) need to satisfy the following conditions:

xCur!=((xRef+128)/64)*64
yCur!=(yRef/64)*64

numOfP=IscNumOfNewPv+IscNumofReusedPv, if a value of IscSubtypeFlag=1:
i. If a product of a width and a height of a current coding unit is greater than 64, a value of numOfP is not to be greater than 15.
ii. If a product of a width and a height of a current coding unit is greater than 32 (that is, 8×8, 4×16, or 16×4), numOfP≤10.
iii. If a product of a width and a height of a current coding unit is greater than 16 (that is, 8×4 or 4×8), numOfP≤5.
iv. If a product of a width and a height of a current coding unit is 4×4, numOfP≤2.

All point vectors used in the current coding unit are stored in a point prediction information table PpInfoList [15][2]. Point vectors in PpInfoList [15][2] include two parts, and one part is from a historical point prediction information table PrevPpInfoList [28][2], where a quantity of point vectors in the historical point prediction information table≤28. The other part is a point vector newly appearing in the current coding unit.

If the current coding unit uses an ordinary string sub-mode, a sum of a quantity of matching strings, a quantity of incompletely matching strings including at least one matching sample, a quantity of unmatching samples, and IscPartNumSplit are to be less than or equal to one fourth of a quantity of samples of the current coding unit. On the contrary, if the current coding unit uses a non-ordinary string sub-mode, a sum of a quantity of equal-value strings, a quantity of unit base vector strings, a quantity of unmatched samples, and IscPartNumSplit are to be less than or equal to one fourth of a quantity of samples of the current coding unit.

A reference range limit of the intra block copy prediction mode and a reference range limit of the intra string copy prediction mode may have different limitation methods in different standards. In this disclosure, that the displacement vector is a valid vector indicates that the displacement vector is to meet a reference range limit. A specific limitation method is not limited to a reference range limit of AVS3.
(iii) Intra string copy prediction non-ordinary string sub-mode

The intra string copy prediction non-ordinary string sub-mode is also referred to as an equal-value string and unit vector string mode, and this method is adopted to the AVS3 standard in October 2020. FIG. 4c is a schematic flowchart of an intra string copy prediction non-ordinary string sub-mode according to an embodiment of this disclosure. As shown in FIG. 4c, similar to the intra string copy prediction mode, in this mode, an encoding/decoding block is partitioned into a series of pixel strings or unmatched pixels according to a scanning order. A type of the pixel string may be an equal-value string type or a unit base vector string type. The equal-value string is characterized in that all pixels in the pixel string have the same predicted value. A unit vector string (also referred to as a unit base vector string, a unit offset string, a copy-above string, or the like) is characterized in that a displacement vector of the unit vector string is (0,−1), and implementation of the unit vector string is relatively simple. For each pixel of the string, an upper pixel is used as a predicted value of a current pixel. In an equal-value string mode, a type, a length, and predicted value information of each string of a current coding block need to be encoded in a bitstream. Correspondingly, a decoder side exports a predicted sample from information obtained by decoding from the bitstream.

### (4) Ordinary Intra Prediction Mode

In AVS3, the intra prediction mode may include: an intra block copy prediction mode, an intra string copy prediction mode, and an ordinary intra prediction mode. The ordinary intra prediction mode may be classified into: an ordinary luminance intra prediction mode, an ordinary chrominance intra prediction mode, and a spatial angular weighted prediction luminance intra prediction mode. In this disclosure, a chrominance block copy intra prediction mode may also be used as a sub-mode of the ordinary chrominance intra prediction mode.

### (i) Ordinary Luminance Intra Prediction Mode

FIG. 4d is a schematic diagram of an ordinary luminance intra prediction mode according to an embodiment of this disclosure. As shown in FIG. 4d, an ordinary luminance intra prediction mode whose value of IntraLumaPredMode is 0 is a DC mode. An ordinary luminance intra prediction mode whose value of IntraLumaPredMode is 1 is a Planer mode. An ordinary luminance intra prediction mode whose value of IntraLumaPredMode is 2 is a Bilinear mode. By analogy, the ordinary luminance intra prediction mode may be classified, based on different values of IntraLumaPredMode, into various modes shown in Table 1.

TABLE 1
Ordinary luminance intra prediction mode

| IntraLumaPredMode | Intra prediction mode |
|---|---|
| 0 | Intra_Luma_DC |
| 1 | Intra_Luma_Plane |
| 2 | Intra_Luma_Bilinear |
| 3 to 11 | Intra_Luma_Angular |
| 12 | Intra_Luma_Vertical |
| 13 to 23 | Intra_Luma_Angular |
| 24 | Intra_Luma_Horizontal |
| 25 to 32 | Intra_Luma_Angular |
| 33 | Intra_Luma_PCM |
| 34 to 65 | Intra_Luma_Angular |

In the foregoing Table 1, Intra_Luma_Horizontal, Intra_Luma_Vertical, and Intra_Luma_Angular are angular prediction modes, and the remaining modes are non-angular prediction modes.

### (ii) Ordinary Chrominance Intra Prediction Mode

TABLE 2
Chrominance prediction block intra prediction mode

| IntraChromaPredMode | Intra prediction mode |
|---|---|
| 0 | Intra_Chroma_DM (where a value of |
| | IntraLumaPredMode is not equal to 33) |
| 0 | Intra_Chroma_PCM (where a value of |
| | IntraLumaPredMode is equal to 33) |
| 1 | Intra_Chroma_DC |
| 2 | Intra_Chroma_Horizontal |
| 3 | Intra_Chroma_Vertical |
| 4 | Intra_Chroma_Bilinear |
| 5 | Intra_Chroma_TSCPM |
| 6 | Intra_Chroma_TSCPM_LT |
| 7 | Intra_Chroma_TSCPM_L |
| 8 | Intra_Chroma_TSCPM_T |
| 9 | Intra_Chroma_PMC |
| 10 | Intra_Chroma_PMC_LT |
| 11 | Intra_Chroma_PMC_L |
| 12 | Intra_Chroma_PMC_T |
| 13 | Intra_Chroma_EPMC |
| 14 | Intra_Chroma_EPMC_LT |
| 15 | Intra_Chroma_EPMC_L |
| 16 | Intra_Chroma_EPMC_T |
| 17 | Intra_Chroma_EPMC2 |
| 18 | Intra_Chroma_EPMC2_LT |
| 19 | Intra_Chroma_EPMC2_L |
| 20 | Intra_Chroma_EPMC2_T |

In the foregoing Table 2, TSCPM, PMC, and EPMC are cross-component prediction modes, and a DM mode is an inherited mode.

### (5) Template Matching

To further improve compression efficiency of the VVC standard, Template matching (TM) for motion refinement on a decoding side is provided. In a TM mode, motion refinement is achieved by constructing template from left and above neighboring reconstructed samples and identifying a closest match between a template in a current picture and a reference frame.

FIG. 4e is a schematic flowchart of template matching according to an embodiment of this disclosure. As shown in FIG. 4e, a better MV is searched for within a search range of [−8, +8] pixels based on initial motion of the current CU. Template matching is previously proposed in JVET-J0021. In ECM, there are some modifications in template matching: A search step is determined based on an AMVR mode, and the TM may be cascaded to a bilateral matching process. In addition, the template matching is further configured for determining a displacement vector, a displacement vector offset, resorting a merge index of a merge candidate list and an AMVP candidate list, determining a reference line of an intra prediction mode, and the like.

### (6) Intra Prediction Motion Vector Prediction in AVS3

Intra block copy (IBC) and intra string copy (ISC) are two screen content coding tools in AVS3, both of which derive a predicted value of a coding unit by using a current picture as reference and through motion compensation. Considering that the IBC and the ISC have similar reference regions, and a block vector (BV) and a string vector (SV) have relatively high correlation, coding efficiency may be further improved by allowing a prediction between the IBC and the ISC. In AVS3, displacement vector information, size information, and a quantity of times of repetition of these two types of coding blocks are recorded by using an intra prediction historical motion information table (IntraHMVP) similar to the HMVP, and a prediction block vector (BVP) and a prediction string vector (SVP) are exported by using the IntraHMVP. To support parallel coding, if a current largest coding unit is the 1^{st} largest coding unit in a current row in a current slice, a value of CntIntraHmvp in the intra prediction historical motion information table is initialized to be 0.
(i) For the IBC coding block, a method referred to as class-based block vector prediction (CBVP for short) is used in AVS3 to derive a BVP, and in this method, candidate BVs in the IntraHMVP may be classified based on the following conditions.

Class 0: An area of a historical coding block is greater than or equal to 64 pixels.

Class 1: A frequency of BV is greater than or equal to 2.

Class 2: Coordinates of an upper left corner of the historical coding block are located to the left of coordinates of an upper left corner of the current block.

Class 3: Coordinates of an upper left corner of the historical coding block are located above coordinates of an upper left corner of the current block.

Class 4: Coordinates of an upper left corner of the historical coding block are located at an upper left side of coordinates of an upper left corner of the current block.

Class 5: Coordinates of an upper left corner of the historical coding block are located at an upper right side of coordinates of an upper left corner of the current block.

Class 6: Coordinates of an upper left corner of the historical coding block are located at a lower left side of coordinates of an upper left corner of the current block.

In addition, a displacement vector index (which may be referred to as an index for short) may be encoded in a video bitstream. The index indicates an index that is of a class corresponding to a best candidate BV and that is in a CBVP list. For example, if the index is “6”, the category corresponding to the best candidate BV and that is in the CBVP list is class 6. Subsequently, the decoder side may obtain a corresponding BVP by decoding in the CBVP list based on the index.

(ii) For the ISC coding block, similarly, an index needs to be encoded for each string, and the index indicates a position of an SVP of a corresponding string in the IntraHMVP. Similar to a skip mode in inter prediction, an SV of a current string is equal to an SVP, and therefore, a string vector difference SVD between the SV and the SVP does not need to be encoded.

### (7) Color Format of Video Picture

YUV is a color coding format, and is mainly configured for optimizing transmission of a color video signal. Compared with RGB video signal transmission, a greatest advantage of YUV lies in occupying only an extremely small bandwidth (while RGB needs simultaneous transmission of three independent video signals). “Y” represents luminance or luma, that is, a grayscale value. “U” and “V” indicate chrominance (or chroma), are for describing picture color and saturation, and are configured for specifying color of a pixel. “Luminance” is established by using an RGB input signal by superimposing particular parts of the RGB signal together. “Chrominance” defines two aspects of color: hue and saturation, which are represented by Cr and Cb respectively. Cr reflects a difference between a red part of the RGB input signal and a luminance value of the RGB signal, and Cb reflects a difference between a blue part of the RGB input signal and a luminance value of the RGB signal. Importance of using the YUV color format is that a luminance signal Y and chrominance signals U and V of the YUV color format are separated. If a picture only includes a Y component (a luminance component) but does not include U and V components (chrominance components), the picture is a black-and-white grayscale picture. In daily life, a color television uses a YUV format to represent a picture, to resolve a compatibility problem between the color television and a black-and-white television based on the luminance component Y, and ensure that the black-and-white television can also receive a color television signal.

A storage format of a YUV video bitstream is closely related to a sampling method of the YUV video bitstream. FIG. 4f is a schematic diagram of a video sampling method according to an embodiment of this disclosure. As shown in FIG. 4f, mainstream YUV sampling formats mainly include the following three types: YUV4:4:4, YUV4:2:2, YUV4:2:0. Symbol “A:B:C” describes sampling frequencies of U and V with respect to Y

YUV4:4:4 sampling represents: Downsampling is not performed on a chrominance channel. In other words, in this sampling method, each Y component corresponds to one group of UV components.

YUV4:2:2 sampling represents: Horizontal downsampling is performed in a 2:1 format, and there is no vertical downsampling. For each scan line, every two U or V samples include four Y samples. In other words, in this sampling method, every two Y components share one group of UV components.

YUV4:2:0 sampling represents: Horizontal downsampling is performed in a 2:1 format and vertical downsampling is performed in a 2:1 format. In other words, in this sampling method, every four Y components share one group of UV components.

### (8) Block Partition Structure in AVS3

### (i) Basic Block Partition Structure

In AVS3, basic block partition structures based on QT, BT, and EQT are used. A quadtree (QT) partition structure is used in a previous-generation AVS2 standard, to be specific, one CU is partitioned into four sub-CUs. In addition to supporting quadtree partitioning, AVS3 also supports binary-tree (BT) and EQT partitioning. In BT, a CU may be partitioned into two sub-CUs that are arranged either side-by-side or one above the other. EQT includes both horizontal and vertical H-shaped partitioning modes, where one CU is partitioned into 4 sub-CUs.

For a representation manner of the basic block partition structures of QT, BT, and EQT in AVS3 in a video bitstream, refer to FIG. 4g. FIG. 4g is a schematic diagram of a structure of basic block partition according to an embodiment of this disclosure. As shown in FIG. 4g, for any coding unit (CU), it is determined whether to perform QT partitioning. If it is determined to perform QT partitioning, quadtree partitioning is directly performed to obtain a QT structure. If it is determined to skip QT partitioning, it is necessary to further determine whether to skip partitioning (non-split). If partitioning is skipped, the determination terminates. If the partitioning is needed, it is necessary to further determine whether to perform EQT partitioning or BT partitioning. If the EQT partitioning needs to be performed, it is necessary to determine whether to perform horizontal (Hor) partitioning or vertical (Ver) partitioning. Similarly, if the BT partitioning needs to be performed, it is also necessary to determine whether to perform horizontal (Hor) partitioning or vertical (Ver) partitioning. Finally, based on the foregoing partitioning modes, the current coding unit may be partitioned into a basic block structure of QT, BT, or EQT.

### (ii) Chrominance Tree Partitioning Limit

A luminance component and a chrominance component of a coding unit in a video bitstream in AVS3 are usually partitioned and encoded by using the same block partition structure. To be specific, the luminance component of the coding unit is partitioned into a plurality of luminance blocks, and the chrominance component of the coding unit is partitioned into a plurality of chrominance blocks. To reduce complexity, AVS3 limits minimum lengths or widths of the luminance block and the chrominance block to at least four pixels. For a coding unit in a YUV420 format, four pixels of a chrominance component correspond to eight pixels of a luminance component. When block partitioning is performed on the coding unit, if a size of a block obtained through partitioning is less than a minimum value, partitioning is skipped. Because a chrominance block in the YUV420 format has a smaller size, there may be a case in which the chrominance block stops being partitioned and a luminance block continues to be partitioned. In this case, one chrominance block may correspond to a plurality of luminance blocks. This case in which partition structures of the luminance block and the chrominance block are inconsistent is also referred to as a local separate tree (LST). AVS3 allows luminance and chrominance to be separately encoded. Particularly, for the chrominance block, a coding mode is selected based on information about a luminance sample point corresponding to a position of a chrominance sample point at a lower right corner position of the chrominance block. If an inter prediction mode is used for a luminance co-located block (also referred to as a co-located luminance block), inter motion compensation is performed on the chrominance block by using a reference frame and displacement vector information of the luminance co-located block, to export a predicted value. Otherwise, a predicted value of the chrominance block is exported by using an available intra prediction mode. The chrominance block allows to select an intra prediction mode different from that of the luminance block.

### (9) Interpolation of Chrominance Block Copy Intra Prediction

### (i) Chrominance Sample Point

FIG. 4h is a schematic diagram of a position during chrominance block copy intra prediction according to an embodiment of this disclosure. positions of sample points in a chrominance sample point matrix of a reference picture are shown in FIG. 4h. A, B, C, and D are neighboring integer-pixel sample points, dx and dy are horizontal and vertical distances between a fractional-pixel sample a (dx, dy) next to the integer-pixel sample point A and A, dx is equal to fx & 1, and dy is equal to fy & 1, where (fx, fy) is coordinates of the fractional-pixel sample in a chrominance sample matrix with ½ precision. Further, FIG. 4i is a schematic diagram of positions of fractional-pixel sample points according to an embodiment of this disclosure. For specific positions of an integer pixel Ax, y and surrounding three fractional-pixel sample points ax, y(dx, dy), refer to FIG. 4i.

### (ii) Chrominance Filter Coefficient

TABLE 3
Chrominance filter coefficient

| Array identifier | Filter coefficient |
|---|---|
| C[0] | {64, 0} |
| C[1] | (32, 32} |

A fractional-pixel point where dx=0 or dy=0 may be obtained by directly performing interpolation based on a chrominance integer-pixel point. A point where neither dx nor dy is equal to 0 may be obtained through calculation by using a fractional-pixel point on an integer-pixel row (dy=0), where

```
  if (dx==0) {
  ax, y(0, dy)=Clip3(0, (1<<BitDepth)−1, (C[dy][0]*Ax, y+C[dy][1]*Ax,
  y+1+32)>>6)
  }
  else if (dy==0) {
  ax, y(dx, 0)=Clip3(0, (1<<BitDepth)−1, (C[dx][0]*Ax,
  y+C[dx][1]*Ax+1, y+32)>>6)
  }
  else {
  ax, y(dx, dy)=Clip3(0, (1<<BitDepth)−1, (C[dy][0]*a′x,
  y(dx, 0)+C[dy][1]*a′x, y+1(dx,
0)+(1<<(19−BitDepth)))>>(20−BitDepth))
  }
```

A, y (dx, 0) is a temporary value of a fractional pixel on the integer-pixel row, and is defined as:

a′x, y(dx, 0)=(C[dx][0]*Ax, y+C[dx][1]*Ax+1,
y+((1<<(BitDepth−8))>>1))>>(BitDepth−8)

### II. Video Decoding

On a decoder side, for each CU, after a video bitstream is obtained, the video bitstream first undergoes entropy decoding to obtain information about various predictive coding modes and quantized transform coefficients, and then the transform coefficients undergo inverse quantization and inverse transform to obtain a residual video signal (also referred to as a difference). In addition, based on the known information about the predictive coding mode, a predicted signal (or referred to as a predicted value) corresponding to the CU may be obtained, and the residual video signal and the predicted signal are added, to obtain a reconstructed video signal. The reconstructed video signal may be configured for reconstructing a decoded picture corresponding to the CU. Finally, the reconstructed video signal needs to undergo a loop filtering operation to generate a final output signal.

Based on the foregoing related descriptions, an embodiment of this disclosure provides a video processing solution. The video processing solution is applicable to a video coder or a video compression product that uses a motion compensation technology (such as an inter prediction mode, an intra block copy mode, and an intra string copy mode), thereby facilitating improving of video compression performance. In some examples, a general principle of the video processing solution is as follows.

On an encoder side: A current chrominance block in a video is determined, a chrominance block copy intra prediction mode being used for the current chrominance block. A target displacement vector of a luminance co-located block corresponding to the current chrominance block is obtained. A predicted value of the current chrominance block is determined based on the target displacement vector. A video is encoded based on the predicted value of the current chrominance block to generate a video bitstream, and the video bitstream is transmitted to a decoder side.

On the decoder side: After the video bitstream transmitted by the encoder side is received, a current chrominance block in the video bitstream may be determined, a chrominance block copy intra prediction mode being used for the current chrominance block. A target displacement vector of a luminance co-located block corresponding to the current chrominance block is obtained. A predicted value of the current chrominance block is determined based on the target displacement vector. The predicted value of the current chrominance block is configured for reconstructing a decoded picture corresponding to the chrominance block.

In view of the above, during video encoding/decoding, this disclosure provides a new prediction mode for the current chrominance block. To be specific, when it is determined that the chrominance block copy intra prediction mode is used for the current chrominance block, the predicted value of the current chrominance block can be determined by using the displacement vector information of the luminance co-located block, without needing to perform intra prediction processing on the current chrominance block, so that encoding/decoding efficiency of the current chrominance block is improved, and effectively improve coding performance.

A video processing system provided in embodiments of this disclosure is described below.

FIG. 5 is a schematic diagram of an architecture of a video processing system according to an embodiment of this disclosure. The video processing system 50 may include an encoding device 501 and a decoding device 502. The encoding device 501 is located on an encoder side, and the decoding device is located on a decoder side. The encoding device 501 may be a terminal, or a server. The decoding device 502 may be a terminal or a server, and a communication connection may be established between the encoding device 501 and the decoding device 502 in a wired or wireless manner. The terminal may be a mobile phone, a tablet computer, a notebook computer, a palmtop computer, a mobile internet device (MID), an in-vehicle device, an aircraft, a wearable device (a smart device, for example, a smart watch, a smart band, or a pedometer), a virtual reality device (for example, a Virtual Reality (VR) device or an Augmented Reality (AR) device), or the like. The server may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), or a big data and artificial intelligence platform.

### (1) for the Encoding Device 501:

The encoding device 501 may obtain a to-be-encoded video. The video may be obtained in a manner of being captured by a camera device or being generated by a computer. The camera device may be a hardware component disposed in the encoding device 501. For example, the camera device may be an ordinary camera, a three-dimensional camera, a light field camera, or the like disposed in the terminal. The camera device may alternatively be a hardware apparatus connected to the encoding device 501, for example, a camera connected to a server.

One video includes one or more video frames, and the encoding device 501 may partition each video into one or more CUs, and encode each CU. When encoding any CU, the encoding device determines a current chrominance block being encoded, and a chrominance block copy intra prediction mode is used for the current chrominance block. A target displacement vector of a luminance co-located block corresponding to the current chrominance block is obtained. A predicted value of the current chrominance block is determined based on the target displacement vector. The predicted value of the current chrominance block may be understood as a predicted signal corresponding to the current chrominance block, and the predicted value of the current chrominance block may be configured for reconstructing a decoded picture corresponding to the current chrominance block. The video is encoded based on the predicted value of the current chrominance block to generate a video bitstream.

The encoding device 501 performs transform coding, quantization, entropy coding, and the like on the video based on the predicted value of the chrominance block of the current CU to obtain the video bitstream, and transmits the video bitstream to the decoding device 502, so that the decoding device 502 decodes the video bitstream.

### (2) for the Decoding Device 502:

After receiving the video bitstream transmitted by the encoding device 501, the decoding device 502 may decode the video bitstream and reconstruct a video corresponding to the video bitstream. In some examples, when decoding any CU, the decoding device 502 determines a current chrominance block of a CU (hereinafter referred to as a current coding unit) being decoded, and the chrominance block copy intra prediction mode is used for the current chrominance block. A target displacement vector of a luminance co-located block corresponding to the current chrominance block is obtained. A predicted value of the current chrominance block is determined based on the target displacement vector. The predicted value of the current chrominance block may be understood as a predicted signal corresponding to the current chrominance block, and the predicted value of the current chrominance block may be configured for reconstructing a decoded picture corresponding to the current chrominance block. The video is encoded based on the predicted value of the current chrominance block to generate a video bitstream.

Whether the intra copy prediction mode is used for the current chrominance block is indicated by mode indication information obtained by decoding the video bitstream. The mode indication information includes at least one of the following: sequence header flag, picture header flag, slice header flag, coding unit flag, implicit information, or chrominance indication information. The following describes indication manners of different types of mode indication information in detail.

1. If the mode indication information is the sequence header flag, the mode indication information is set in a sequence header of a current sequence to which the current chrominance block belongs, and when the sequence header flag is a first preset value, the chrominance block copy intra prediction mode is allowed to be used for the current chrominance block, or when the sequence header flag is a second preset value, the chrominance block copy intra prediction mode is not allowed to be used for the current chrominance block.

2. If the mode indication information is a picture header flag, the mode indication information is set in a picture header of a current picture to which the current chrominance block belongs, and when the picture header flag is a first preset value, the chrominance block copy intra prediction mode is allowed to be used for the current chrominance block, or when the picture header flag is a second preset value, the chrominance block copy intra prediction mode is not allowed to be used for the current chrominance block.

3. If the mode indication information is a slice header flag, the mode indication information is set in a slice header of a current slice to which the current chrominance block belongs, and when the slice header flag is a first preset value, the chrominance block copy intra prediction mode is allowed to be used for the current chrominance block, or when the slice header flag is a second preset value, the chrominance block copy intra prediction mode is not allowed to be used for the current chrominance block;

4. If the mode indication information is a coding unit flag, the mode indication information is set in a current coding unit, and when the coding unit flag is a first preset value, the chrominance block copy intra prediction mode is used for the current chrominance block, or when the coding unit flag is a second preset value, the chrominance block copy intra prediction mode is not used for the current chrominance block.

5. If the mode indication information is implicit information, when the implicit information indicates that a luminance sample point at a preset position within the luminance co-located block corresponding to the current chrominance block satisfies a preset condition, the chrominance block copy intra prediction mode is used for the current chrominance block.

6. If the mode indication information is the chrominance indication information, when the chrominance indication information indicates that a preset intra prediction mode (for example, a derived mode (DM)) is used for the current chrominance block and a luminance sample point at a preset position within the luminance co-located block satisfies a preset condition, the chrominance block copy intra prediction mode is used for the current chrominance block.

In this embodiment of this disclosure, the mode indication information indicating the prediction mode of the current chrominance block mode may be obtained by decoding the video bitstream, and when the chrominance block copy intra prediction mode is used for the current chrominance block, the predicted value of the current chrominance block may be determined by using the target displacement vector of the luminance co-located block corresponding to the current chrominance block.

Further, if it is determined that residual decoding needs to be performed on the current chrominance block, the decoding device 502 performs inverse quantization and inverse transform on a quantized transform coefficient, to obtain a difference of the current chrominance block, performs superposition based on the predicted value and the difference of the current chrominance block, to obtain a reconstructed value of the current chrominance block, and then reconstructs a decoded picture corresponding to the current chrominance block based on the reconstructed value. The decoded picture obtained by decoding may be used as a reference picture for decoding another CU, and may also be configured for reconstructing a video.

Embodiments of this disclosure provide a new prediction mode for the current chrominance block during video encoding/decoding. To be specific, when it is determined that the chrominance block copy intra prediction mode is used for the current chrominance block, the predicted value of the current chrominance block can be determined by using the displacement vector information of the luminance co-located block, without needing to perform intra prediction processing on the current chrominance block, so that encoding/decoding efficiency of the current chrominance block is improved, thereby effectively improving coding performance.

A video processing method provided in embodiments of this disclosure is described below. FIG. 6 is a schematic flowchart of a video processing method according to an embodiment of this disclosure. The video processing method may be performed by the decoding device in the foregoing video processing system. The video processing method described in this embodiment may include the following operations S601 to S603.

S601: Determine a current chrominance block in a video bitstream, a chrominance block copy intra prediction mode being used for the current chrominance block.

In this disclosure, the current chrominance block is a chrominance block being decoded currently, and a chrominance block is a coding block including only a chrominance component. In other words, a chrominance block is a block of a chrominance component in a coding unit, and a luminance block is a block of a luminance component in the coding unit. The block may include, but is not limited to: a coding unit, a prediction unit, a transform unit, a prediction block, and a transform block.

In an implementation example, a video bitstream is decoded, to obtain mode indication information, where the mode indication information indicates whether an intra string copy prediction mode is used for the current chrominance block. The mode indication information includes at least one of the following: sequence header flag, picture header flag, slice header flag, coding unit flag, implicit information, or chrominance indication information. The chrominance block copy intra prediction mode is a prediction mode independent of an ordinary intra prediction mode; or the chrominance block copy intra prediction mode is a sub-mode of an ordinary intra prediction mode; and the ordinary intra prediction mode includes at least one of the following: an intra prediction direct current mode, an angle-based intra prediction mode, a two-step cross-component prediction mode, or a prediction mode of deriving a predicted value based on an intra reference pixel.

(1) If the mode indication information is a sequence header flag seq_cibc_flag, the mode indication information is set in a sequence header of a current sequence to which the current chrominance block belongs, and when the sequence header flag seq_cibc_flag is a first preset value (for example, 1), the chrominance block copy intra prediction mode is allowed to be used for the current chrominance block, or when the sequence header flag seq_cibc_flag is a second preset value (for example, 0), the chrominance block copy intra prediction mode is not allowed to be used for the current chrominance block. In this case, the chrominance block copy intra prediction mode is a prediction mode independent of an ordinary intra prediction mode.

In one embodiment, whether the current chrominance block copy intra prediction mode is used may be determined based on another sequence header, which includes the following implementations:
a. A sequence header flag seq_ibc_flag indicating whether IBC is used exists in a video bitstream, and when a value of seq_ibc_flag is 1, seq_cibc_flag is decoded.
b. A sequence header flag seq_isc_flag indicating whether ISC is used exists in a video bitstream, and when a value of seq_isc_flag is 1, seq_cibc_flag is decoded.
c. A sequence header flag seq_isc_ordinary_flag indicating whether an ISC ordinary string sub-mode is used exists in a video bitstream, and when a value of seq_isc_ordinary_flag is 1, seq_cibc_flag is decoded.
d. A sequence header flag seq_isc_non_ordinary_flag indicating whether an ISC non-ordinary string sub-mode is used exists in a video bitstream, and when a value of seq_isc_non_ordinary_flag is 1, seq_cibc_flag is decoded.
e. A combination of the foregoing methods a to d. For example, seq_ibc_flag and seq_isc_flag exist in a video bitstream, and only when a value of at least one of seq_ibc_flag and seq_isc_flag is 1, seq_cibc_flag is decoded.
f. The foregoing methods a to d may be implicit methods. To be specific, seq_cibc_flag does not need to be decoded from a video bitstream, and the flag seq_cibc_flag is directly determined based on values of the foregoing flags (seq_ibc_flag, seq_isc_flag, seq_isc_ordinary_flag, and seq_isc_non_ordinary_flag). For example, if seq_ibc_flag and seq_isc_flag exist in a video bitstream, and a value of at least one of seq_ibc_flag and seq_isc_flag is 1, a value of seq_cibc_flag is set to 1. Alternatively, if seq_ibc_flag exists in a video bitstream and a value of seq_ibc_flag is 1, a value of seq_cibc_flag is set to 1. Alternatively, if seq_isc_flag exists in a bitstream and a value of seq_isc_flag is 1, a value of seq_cibc_flag is set to 1.

(2) If the mode indication information is a picture header flag pic_cibc_flag, the mode indication information is set in a picture header of a current picture to which the current chrominance block belongs, and when the picture header flag pic_cibc_flag is a first preset value (for example, 1), the chrominance block copy intra prediction mode is allowed to be used for the current chrominance block, or when the picture header flag pic_cibc_flag is a second preset value (for example, 0), the chrominance block copy intra prediction mode is not allowed to be used for the current chrominance block. In this case, the chrominance block copy intra prediction mode is a prediction mode independent of an ordinary intra prediction mode.

In one embodiment, whether the current chrominance block copy intra prediction mode is used may be determined based on another sequence header, which includes the following implementations:
a. A picture header flag pic_ibc_flag indicating whether IBC is used exists in a video bitstream, and when a value of pic_ibc_flag is 1, pic_cibc_flag is decoded.
b. A picture header flag pic_isc_flag indicating whether ISC is used exists in a video bitstream, and when a value of pic_isc_flag is 1, pic_cibc_flag is decoded.
c. A picture header flag pic_isc_ordinary_flag indicating whether an ISC ordinary string sub-mode is used exists in a video bitstream, and when a value of pic_isc_ordinary_flag is 1, pic_cibc_flag is decoded.
d. A picture header flag pic_isc_non_ordinary_flag indicating whether an ISC non-ordinary string sub-mode is used exists in a video bitstream, and when a value of pic_isc_non_ordinary_flag is 1, pic_cibc_flag is decoded.
e. A combination of the foregoing methods a to d. For example, pic_ibc_flag and pic_isc_flag exist in a video bitstream, and only when a value of at least one of pic_ibc_flag and pic_isc_flag is 1, pic_cibc_flag is decoded.
f. The foregoing methods a to d may be implicit methods. To be specific, pic_cibc_flag does not need to be decoded from a video bitstream, and the flag pic_cibc_flag is directly determined based on values of the foregoing flags (pic_ibc_flag, pic_isc_flag, pic_isc_ordinary_flag, and pic_isc_non_ordinary_flag). For example, if pic_ibc_flag and pic_isc_flag exist in a video bitstream, and a value of at least one of pic_ibc_flag and pic_isc_flag is 1, a value of pic_cibc_flag is set to 1. Alternatively, if pic_ibc_flag exists in a video bitstream and a value of pic_ibc_flag is 1, a value of pic_cibc_flag is set to 1. Alternatively, if pic_isc_flag exists in a bitstream and a value of pic_isc_flag is 1, a value of pic_cibc_flag is set to 1.

(3) If the mode indication information is a slice header flag patch_cibc_flag, the mode indication information is set in a slice header of a current slice to which the current chrominance block belongs, and when the slice header flag patch_cibc_flag is a first preset value (for example, 1), the chrominance block copy intra prediction mode is allowed to be used for the current chrominance block, or when the slice header flag patch_cibc_flag is a second preset value (for example, 0), the chrominance block copy intra prediction mode is not allowed to be used for the current chrominance block. In this case, the chrominance block copy intra prediction mode is a prediction mode independent of an ordinary intra prediction mode.

In one embodiment, whether the current chrominance block copy intra prediction mode is used may be determined based on another sequence header, which includes the following implementations:
a. A slice header flag patch_ibc_flag indicating whether IBC is used exists in a video bitstream, and when a value of patch_ibc_flag is 1, patch_cibc_flag is decoded.
b. A slice header flag patch_isc_flag indicating whether ISC is used exists in a video bitstream, and when a value of patch_isc_flag is 1, patch_cibc_flag is decoded.
c. A slice header flag patch_isc_ordinary_flag indicating whether an ISC ordinary string sub-mode is used exists in a video bitstream, and when a value of patch_isc_ordinary_flag is 1, patch_cibc_flag is decoded.
d. A slice header flag patch_isc_non_ordinary_flag indicating whether an ISC non-ordinary string sub-mode is used exists in a video bitstream, and when a value of patch_isc_non_ordinary_flag is 1, patch_cibc_flag is decoded.
e. A combination of the foregoing methods a to d. For example, patch_ibc_flag and patch_isc_flag exist in a video bitstream, and only when a value of at least one of patch_ibc_flag and patch_isc_flag is 1, patch_cibc_flag is decoded.
f. The foregoing methods a to d may be implicit methods. To be specific, patch_cibc_flag does not need to be decoded from a video bitstream, and the flag patch_cibc_flag is directly determined based on values of the foregoing flags (patch_ibc_flag, patch_isc_flag, patch_isc_ordinary_flag, and patch_isc_non_ordinary_flag). For example, if patch_ibc_flag and patch_isc_flag exist in a video bitstream, and a value of at least one of patch_ibc_flag and patch_isc_flag is 1, a value of patch_cibc_flag is set to 1. Alternatively, if patch_ibc_flag exists in a video bitstream and a value of patch_ibc_flag is 1, a value of patch_cibc_flag is set to 1. Alternatively, if patch_isc_flag exists in a bitstream and a value of patch_isc_flag is 1, a value of patch_cibc_flag is set to 1.

(4) If the mode indication information is a coding unit flag cu_cibc_flag, the mode indication information is set in a current coding unit, and when the coding unit flag cu_cibc_flag is a first preset value (for example, 1), the chrominance block copy intra prediction mode is used for the current chrominance block, or when the coding unit flag cu_cibc_flag is a second preset value (for example, 0), the chrominance block copy intra prediction mode is not used for the current chrominance block.

(5) If the mode indication information is implicit information, when the implicit information indicates that a luminance sample point at a preset position within the luminance co-located block corresponding to the current chrominance block satisfies a preset condition, the chrominance block copy intra prediction mode is used for the current chrominance block.

(6) If the mode indication information is chrominance indication information, when the chrominance indication information indicates that a preset intra prediction mode is used for the current chrominance block, for example, the preset intra prediction mode is a derived mode (DM, a unique mode for a chrominance prediction) and a luminance sample point at a preset position within the luminance co-located block satisfies a preset condition, the chrominance block copy intra prediction mode is used for the current chrominance block.

In this embodiment of this disclosure, by decoding the mode indication information set at different positions (for example, the sequence header, the picture header, the slice header, and the coding unit) in the video bitstream, whether the prediction mode used for the current chrominance block of the current coding unit in the video bitstream is the intra copy prediction mode may be indicated. The foregoing mode indication information (1) to (6) indicating whether the chrominance block copy intra prediction mode is used for the current chrominance block may be used alone or in combination. For example, the mode indication information may include: a sequence header flag of a current sequence and a coding unit flag of a current coding unit. When the sequence header flag is a first preset value and the coding unit flag is the first preset value, the chrominance block copy intra prediction mode is used for the current chrominance block. For another example, the mode indication information includes a coding unit flag of a current coding unit, and when the coding unit flag is a first preset value, the chrominance block copy intra prediction mode is used for the current chrominance block. This is not limited in this disclosure.

In an implementation example, in a process of decoding a video bitstream, whether the video bitstream satisfies a decoding condition needs to be determined. If the video bitstream satisfies the decoding condition, the video bitstream is decoded to obtain the mode indication information. In some examples, the decoding condition includes: A color format of the video bitstream is a format including a chrominance component. The format including the chrominance component includes: any one or more of a YUV420 format, a YUV422 format, and a YUV444 format. When the mode indication information is set in a current coding unit to which the current chrominance block belongs, the decoding condition includes any one or more of the following.
i. The current coding unit only includes the chrominance component. The chrominance component may be determined based on a current coding tree component type, and the current coding tree component type includes at least three types: a luminance component, a chrominance component, and a luminance and chrominance component. A coding tree is a partition structure of a coding unit.
ii. The luminance sample point at the preset position within the luminance co-located block corresponding to the current chrominance block satisfies the preset condition. If a plurality of preset positions (for example, 10) exist, a quantity of luminance sample points satisfying the preset condition is: at least one, or greater than or equal to a preset threshold (T=6).

(1) The preset position may be determined through any one of the following methods.
a. In an example, a preset chrominance sample point may be determined in the current chrominance block, and then the preset position of the corresponding luminance sample point within the luminance co-located block is determined based on a position of the preset chrominance sample point. The chrominance sample point means a sample point (that is, a pixel point) in the current chrominance block. For example, the position of the preset chrominance sample point includes: any one or more of a center point position (xC+wC/2, yC+hC/2), (xC+wC/2−1, yC+hC/2−1), (xC+wC/2−1, yC+hC/2), (xC+wC/2, yC+hC/2−1), an upper left corner position (xC+wC−1, yC), an upper right corner position (xC+wC, yC), a lower left corner position (xC, yC+hC−1), and a lower right corner position (xC+wC−1, yC+hC−1). Then, a position of the corresponding luminance sample point within the luminance co-located block may be calculated according to the following equation (2).

(xL,yL)=(xC*scaleX,yC*scaleY) Equation (2)

(xC, yC) in equation (2) means coordinates of an upper left corner position of the current chrominance block, and (xL, yL) means coordinates of an upper left corner position of the luminance co-located block corresponding to the current chrominance block. scaleX means a horizontal sample ratio of a luminance component to a chrominance component in a currently used YUV color format, and scaleY means a vertical sample ratio of the luminance component to the chrominance component in the currently used YUV color format. For example, if the currently used YUV color format is the YUV420 format, scaleX=2 (2:1), and scaleY=2 (2:1). For another example, if the currently used YUV color format is the YUV422 format, scaleX=2 (2:1), and scaleY=1. For still another example, if the currently used YUV color format is the YUV444 format, scaleX=1, and scaleY=1.
b. In another example, the preset position may be directly determined in the luminance co-located block. The preset position may, for example, include: any one or more of preset positions of luminance sample points corresponding to (xL+wL/2, yL+hL/2), (xL+wL/2−1, yL+hL/2−1), (xL+wL/2−1, yL+hL/2), (xC+wC/2, yC+hC/2−1), an upper left corner (xL, yL), an upper right corner (xL+wL−1, yL), a lower left corner (xL, yL+hL−1), and a lower right corner (xL+wL−1, yL+hL−1). In a current video coding standard, motion information is stored based on a block size (for example, 4*4) of a fixed size, and various pieces of sample point information are the same within the size. Therefore, the preset position obtained by using the method is actually equivalent to that of the foregoing operation a.
c. In still another example, the preset position is determined, based on a partitioning mode of the luminance co-located block, within each sub-block obtained by partitioning the luminance co-located block. For example, the preset position may be an upper left corner position of each sub-block. All sample points in a sub-block have the same information.
d. In yet another example, the luminance co-located block is partitioned into M*N sub-blocks, and specified positions within the M*N sub-blocks are used as the preset positions. The specified position includes: any one of a center, an upper left corner, an upper right corner, a lower left corner, and a lower right corner of a sub-block, and M and N being positive integers. For example, an upper left corner of each of 4*4 sub-blocks is selected as the preset position.

(2) The preset condition may be determined through any one of the following methods.
a. The luminance sample point uses any mode in a particular mode set, the particular mode set including: any one or more of an intra block copy prediction mode, an intra string copy prediction ordinary string sub-mode, an intra string copy prediction non-ordinary string sub-mode, or another prediction mode with an intra displacement vector.
b. The luminance sample point has a valid displacement vector. The valid displacement vector means: A luminance co-located block to which the luminance sample point belongs is to meet a reference range limit of the intra block copy prediction mode. Alternatively, a luminance co-located block to which the luminance sample point belongs is to meet a reference range limit of the intra string copy prediction ordinary string sub-mode, and a reference block corresponding to the luminance co-located block is allowed to overlap the luminance co-located block.
c. An intra prediction historical motion information table (or referred to as an intra block copy historical motion information table) of the current chrominance block is not empty.

In this embodiment of this disclosure, in addition to being represented as the chrominance block copy intra prediction mode, the prediction mode used for the current chrominance block may alternatively be represented in other different manners. For example, the prediction mode may alternatively be represented as: an intra copy mode, an intra block copy mode, a chrominance intra copy mode, a chrominance string copy mode, or another prediction mode name. A specific name of the prediction mode used for the current chrominance block is not limited in this disclosure. The chrominance block copy intra prediction mode in this embodiment of this disclosure is characterized by using a chrominance block as a unit, or using a chrominance sub-block as a unit in a process of exporting a predicted value when the predicted value for a chrominance block is exported by using a current frame as a reference frame.

S602: Obtain a target displacement vector of a luminance co-located block corresponding to the current chrominance block.

1. The luminance co-located block corresponding to the current chrominance block is determined.

In an implementation example, a position and a size of the corresponding luminance co-located block may be determined based on a position and a size of the current chrominance block and a color format of a video picture. Assuming that an upper left corner position of the current chrominance block has coordinates of (xC, yC) and a size of (wC, hC), that horizontal and vertical sampling ratios of a luminance component to a chrominance component that correspond to a color format are respectively (scaleX, scaleY), and that the color format is, for example, a YUV420 format, scaleX=2, and scaleY=2. Therefore, the position (xL, yL) and the size (wL, hL) of the luminance co-located block corresponding to the current chrominance block may be calculated according to the following equations 3-1 and 3-2:

(xL,yL)=(xC*scaleX,yC*scaleY) (3-1)

(wL,hL)=(wC*scaleX,hC*scaleY) (3-2)

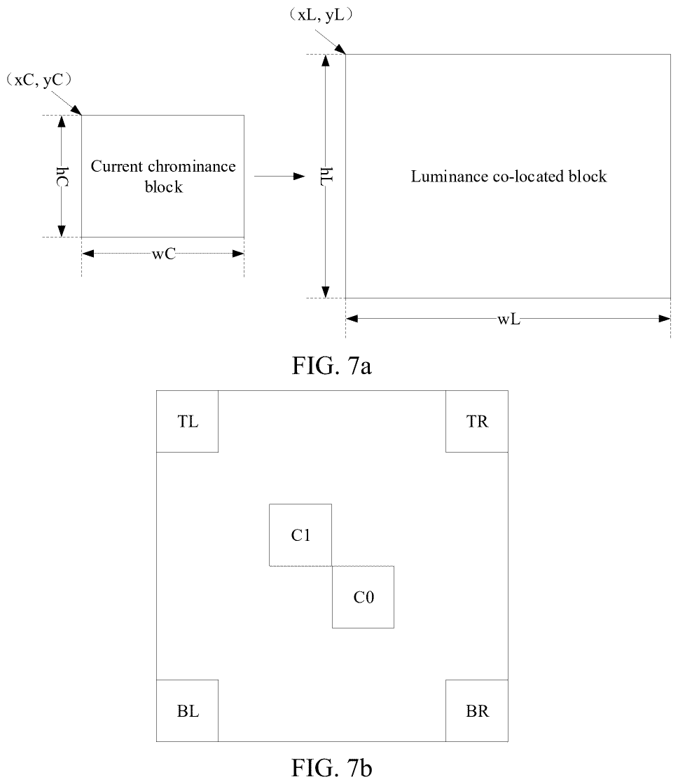

(xL, yL) means a horizontal coordinate xL and a vertical coordinate yL at an upper left corner position of the luminance co-located block, and (wL, hL) means a length wL and a height hL of the luminance co-located block. (xC, yC) means a horizontal coordinate xC and a vertical coordinate yC at an upper left corner position of the current chrominance block, and (wC, hC) means a length wC and a height hC at the upper left corner position of the current chrominance block. FIG. 7a is a schematic flowchart of determination of a luminance co-located block according to an embodiment of this disclosure. As shown in FIG. 7a, assuming that the coordinates (xC, yC) at the upper left corner position of the current chrominance block are (1, 2), the size (wC, hC) of the current chrominance block is (8, 4), and the color format is the YUV420 format, the position and the size of the luminance co-located block corresponding to the current chrominance block can be determined according to Equations 3-1 and 3-2 as (xL, yL)=(1*2, 2*2)=(2, 4), and (wL, hL)=(8*2, 4*2)=(16, 8).

2. The target displacement vector is determined from the luminance co-located block.

In an implementation example, the obtaining a target displacement vector of a luminance co-located block corresponding to the current chrominance block includes: constructing a candidate displacement vector list of the luminance co-located block corresponding to the current chrominance block; and determining the target displacement vector from the candidate displacement vector list. In an actual application, it is not necessary to allocate a memory for constructing the candidate displacement vector list, and the construction may alternatively be implemented through another method. For example, candidate displacement vectors in the candidate displacement vector list may be checked in sequence.

(1) A specific procedure of how to construct the candidate displacement vector list is described in detail.
(i) The candidate displacement vector list of the luminance co-located block corresponding to the current chrominance block is constructed through any one or more of the following methods:
i. A displacement vector of a luminance sample point that is in the luminance co-located block and that satisfies a specified mode is added to the candidate displacement vector list, the specified mode including: any one of an intra block copy prediction mode, an intra string copy prediction ordinary string sub-mode, an intra string copy prediction non-ordinary string sub-mode, an intra template matching mode, an inter prediction mode, an affine movement mode, an inter-intra compound mode, an angular weighted prediction (AWP) mode, a spatial angular weighted prediction (SAWP) mode, and an inter geometrical partitioning mode (GPM).
ii. A displacement vector of a spatially neighboring block corresponding to the luminance co-located block is added to the candidate displacement vector list. The spatially neighboring block is a coding block adjacent to a current coding block (also referred to as a coding unit) in a current frame of a video, and the current frame is a video frame to which the current coding unit belongs. The current coding block is a coding block being decoded in the current frame.
iii. A displacement vector in a historical motion information table or in an intra prediction historical motion information table is added to the candidate displacement vector list.
iv. Offset processing is performed on a candidate displacement vector in operations i to iii and then the candidate displacement vector is added to the candidate displacement vector list, the candidate displacement vectors including: any one or more of the displacement vector of the luminance sample point that is in the luminance co-located block and that satisfies the specified mode, and the displacement vector of the spatially neighboring block corresponding to the luminance co-located block. In some examples, assuming that there is a displacement vector (mvX, mvY), a displacement vector obtained by performing offset processing on the displacement vector may be represented as (mvX+offsetX, mvY+offsetY). Values of offsetX and offsetY may be any integer, for example, offsetX=1, and offsetY=2.
v. If no valid displacement vector exists, the list may be populated with a default displacement vector. The default displacement vector includes: (−w, 0), (0, −h), (−w, −h), (−2*w, 0), (0, −2*h), where “w” means a width of the luminance co-located block, and “h” means a height of the luminance co-located block. Alternatively, the displacement vector in the candidate displacement vector list is set to an invalid value, for example, (0, 0).

A condition that the displacement vector in the candidate displacement vector list needs to satisfy includes at least one of the following.
i. A reference block of the luminance co-located block meets a reference range limit of the intra block copy prediction mode.
ii. A reference block of the luminance co-located block and the displacement vector both meet a reference range limit of the intra string copy prediction ordinary string sub-mode.
iii. The displacement vector does not duplicate any displacement vector in any displacement vector list other than the candidate displacement vector list. In other words, the displacement vector added to the candidate displacement vector list is unique and does not exist in another displacement vector list different from the candidate displacement vector list.
(ii) A sorting manner of displacement vectors in the candidate displacement vector list includes any one of the following.
i. Sorting is performed based on a preset sequence; For example, all displacement vectors are sequentially sorted in a chronological (or reverse chronological) manner based on obtaining moments of the displacement vectors. For example, if obtaining moments of displacement vectors MV1, MV2, and MV3 configured for constructing the candidate displacement vector list are t1, t2, and t3, and t1<t2<t3, a sorting manner of the three displacement vectors MV1, MV2, and MV3 in the candidate displacement vector list is: MV1, MV2, MV3. All the displacement vectors in the candidate displacement vector list may be sequentially sorted from left to right or from top to bottom. For example, if all the displacement vectors in the candidate displacement vector list are sequentially sorted from top to bottom, and the sorted candidate displacement vector list is shown in the following Table 4-1.

TABLE 4-1
Candidate displacement vector list

| Displacement vector | Obtaining moment |
|---|---|
| MV1 | t1 |
| MV2 | t2 |
| MV3 | t3 |

In one embodiment, FIG. 7b is a schematic diagram of sorting of displacement vectors according to an embodiment of this disclosure. As shown in FIG. 7b, if coding blocks corresponding to displacement vectors in the candidate displacement vector list respectively include: C0, C1, TL, TR, BL, and BR, the preset sequence may be: C0, C1, TL, TR, BL, BR.
ii. Sorting is performed based on costs of the displacement vectors. For example, the costs may include but are not limited to: a rate-distortion cost, a sum of absolute differences (SAD), a sum of absolute transformed differences (SATD), a sum of squared errors (SSE), a mean-removed sum of absolute differences (Mean-removed SAD), and a mean-removed sum of squared errors (Mean-removed SSE). The foregoing costs may be calculated in a template matching manner. The following uses the rate-distortion cost as an example. For example, the displacement vectors configured for constructing the candidate displacement vector list include: MV1, MV2, MV3, MV4, and MV5, and a result that a rate-distortion cost of MV1<a rate-distortion cost of MV2<a rate-distortion cost of MV3<a rate-distortion cost of MV4<a rate-distortion cost of MV5 is obtained through calculation by using a template matching manner. Therefore, all the displacement vectors in the candidate displacement vector list are sorted in the following manner: MV1, MV2, MV3, MV4, MV5. All the displacement vectors in the candidate displacement vector list may be sequentially sorted from left to right or from top to bottom. For example, if all the displacement vectors in the candidate displacement vector list are sequentially sorted from left to right, and the sorted candidate displacement vector list is shown in the following Table 4-2.

TABLE 4-2
Candidate displacement vector list

| | | | | | |
|---|---|---|---|---|---|
| MV1 | MV2 | MV3 | MV4 | MV5 | . . . |
| Loss1 | Loss2 | Loss3 | Loss4 | Loss5 | . . . |

Loss1 means the rate-distortion cost of MV1, Loss2 means the rate-distortion cost of MV2, and so on. In Table 4-2, all the displacement vectors are sequentially sorted in ascending order of rate-distortion costs. In another feasible embodiment, all the displacement vectors may alternatively be sorted in descending order of rate-distortion costs. This is not limited in this disclosure.

In one embodiment, costs (such as rate-distortion costs, SADs, SATDs, SSEs, Mean-removed SADs, and Mean-removed SSEs) of all the displacement vectors may be weighted to obtain total costs of all the displacement vectors. Then, sorting is performed based on the total costs of all the displacement vectors.
iii. Sorting is performed based on types of the displacement vectors, the types of the displacement vectors including at least: block vector, string vector, motion vector (motion vector of inter motion), and default vector. A priority of the block vector is greater than a priority of the string vector, the priority of the string vector is greater than a priority of the motion vector, and the priority of the motion vector is greater than a priority of the default vector. In other words, in the candidate displacement vector list, the displacement vectors are sequentially sorted in the following sequence: the block vector, the string vector, the motion vector, and the default vector. For example, the sorted candidate displacement vector list is shown in the following Table 4-3.

TABLE 4-3
Candidate displacement vector list

| Type | Displacement vector |
|---|---|
| Block vector | MV1, MV2 |
| String vector | MV3, MV4 |
| Motion vector | MV5 |
| Default vector | MV6 |

In Table 4-3, displacement vectors MV1 and MV2 both belong to block vectors, MV3 and MV4 both belong to string vectors, MV5 is a motion vector of inter motion, and MV6 is a default vector.
iv. Sorting is performed based on both types of the displacement vectors and rate-distortion costs of the displacement vectors in a combined manner. In some examples, all the displacement vectors in the displacement vector list may be first classified into different classes (a block vector class, a string vector class, and a default vector class), and then sorted in each class based on costs of the displacement vectors. For example, the sorted candidate displacement vector list is shown in the following Table 4-4.

TABLE 4-4
Candidate displacement vector list

| Class | Displacement vector |
|---|---|
| Block vector | MV1 |
| | MV2 |
| String vector | MV3 |
| | MV4 |
| Motion vector | MV5 |
| | MV6 |
| Default vector | MV7 |

In Table 4-4, displacement vectors MV1 and MV2 both belong to block vectors, and a cost of MV1 is less than a cost of MV2. MV3 and MV4 both belong to string vectors, and a cost of MV3 is less than a cost of MV4; MV5 and MV6 both belong to motion vectors, and a cost of MV5 is less than a cost of MV6. MV7 is a default vector.

(2) Then, a specific process of how to determine the target displacement vector is described in detail.

In an implementation example, the target displacement vector is determined from the candidate displacement vector list through any one of the following methods.
(i) A K^{th} displacement vector in the candidate displacement vector list is used as the target displacement vector, K being a positive integer. For example, the 1^{st} displacement vector in the candidate displacement vector list is used as the target displacement vector.
(ii) The target displacement vector is determined from the candidate displacement vector list based on a displacement vector index. The displacement vector index indicates a position of a displacement vector in the candidate displacement vector list, and the displacement vector index may be obtained by decoding a video bitstream. For example, if the displacement vector index is m (where m is a positive integer), the target displacement vector determined based on the displacement vector index is a displacement vector numbered m in the displacement vector list. In one embodiment, only when a quantity of displacement vectors included in the displacement vector list is greater than 1, the displacement vector index is allowed to be obtained by decoding the video bitstream.
(iii) A candidate displacement vector is obtained from the candidate displacement vector list, the candidate displacement vector is scaled based on a color format sampling ratio, and integer-pixel precision of the scaled displacement vector is retained, to obtain the target displacement vector. In some examples, if an obtained candidate displacement vector MV is represented as (5, 3), and a color format is a YUV420 format, where sampling ratios in the YUV420 format are scaleX=2 and scaleY=2, a displacement vector MV′ obtained by scaling the displacement vector represented as (5, 3) is (2.5, 1.5). Further, after integer-pixel precision of the MV′ is retained, an obtained target displacement vector may be (2, 1). The integer-pixel precision of the displacement vector may be retained by rounding upward, or rounding downward. This is not limited in this disclosure.
(iv) The candidate displacement vector is obtained from the candidate displacement vector list, and a displacement vector of a luminance component is used as the target displacement vector. For example, if the obtained candidate displacement vector MV is represented as (5.1, 3.2), precision (integer-pixel precision or fractional-pixel precision) of the displacement vector is retained, and the obtained displacement vector (5.1, 3.2) is directly used as the target displacement vector.

In the foregoing operations 3 and 4, the MV is usually stored in particular precision. For example, in AVS3, an MV is stored in ¼-pixel precision, and an MV of integer-pixel precision is (2, 1), and is scaled up to (8, 4) during storage. In this case, an integer pixel part of the MV may be obtained by MV/4, and a fractional pixel part of the MV is obtained by MV % 4, where “/” indicates division and rounding down, and “%” indicates modulo operation.

S603: A predicted value of the current chrominance block is determined based on the target displacement vector. The predicted value is configured for reconstructing a decoded picture corresponding to the current chrominance block.

In an implementation example, if the target displacement vector has integer-pixel precision, motion compensation is performed on the target displacement vector, to derive the predicted value of the current chrominance block. Alternatively, if the target displacement vector has fractional-pixel precision, interpolation is performed on the target displacement vector, and motion compensation is performed on the target displacement vector undergone the interpolation, to derive the predicted value of the current chrominance block.

In another possible implementation, if no target displacement vector exists in the luminance co-located block corresponding to the current chrominance block, the predicted value of the current chrominance block is exported by using the intra prediction mode. The intra prediction mode includes: a cross-component intra prediction mode, or a specified intra prediction mode. (1) The cross-component intra prediction mode includes: a two-step cross-component prediction mode (TSPCM), and a cross-component linear model (CCLM) prediction mode. (2) The specified intra prediction mode includes: any one or more of an intra prediction direct current (DC) mode, an intra prediction bilinear prediction mode, an intra prediction planar/plane prediction mode, a horizontal-direction intra prediction mode, and a vertical-direction intra prediction mode.

In an implementation example, (1) if the chrominance block copy intra prediction mode is used for the current chrominance block, whether residual decoding needs to be performed on the current chrominance block is determined based on information about a target luminance sample point within the luminance co-located block corresponding to the current chrominance block, the target luminance sample point being a luminance sample point corresponding to the target displacement vector; (2) it is determined that residual decoding needs to be performed on the current chrominance block, the residual decoding is performed on the current chrominance block to obtain a difference; and (3) a decoded picture corresponding to the current chrominance block is reconstructed based on the difference and the predicted value of the current chrominance block. The luminance co-located block corresponding to the current chrominance block includes a plurality of luminance blocks, and a condition for determining that residual decoding does not need to be performed on the current chrominance block includes any one of the following:
i. The intra string copy prediction ordinary string sub-mode is used for a target luminance sample point, and residual encoding does not need to be performed on a luminance block in which the target luminance sample point is located.
ii. An intra string copy prediction mode is used for the target luminance sample point, and residual encoding does not need to be performed on a luminance block in which the target luminance sample point is located.
iii. The intra block copy prediction mode is used for the target luminance sample point, and residual encoding does not need to be performed on a luminance block in which the target luminance sample point is located.
iv. The intra string copy prediction ordinary string sub-mode or the intra block copy prediction mode is used for the target luminance sample point, and residual encoding does not need to be performed on a luminance block in which the target luminance sample point is located.
v. An intra string copy prediction mode or the intra block copy prediction mode is used for the target luminance sample point, and residual encoding does not need to be performed on a luminance block in which the target luminance sample point is located.

A condition for determining whether residual encoding needs to be performed on the luminance block in which the target luminance sample point is located is determined based on: a coefficient flag of the luminance block or a prediction mode of the current chrominance block. For example, in video coding and decoding, each coding block corresponds to one coefficient flag. The coefficient flag indicates whether difference (or referred to as a residual coefficient) coding needs to be performed on the current coding block. If a coefficient flag of the luminance block in which the target luminance sample point is located is 0, a coefficient flag of the current chrominance block is also 0, and residual decoding does not need to be performed on the current chrominance block. For another example, if the prediction mode of the current chrominance block is a skip mode, residual decoding does not need to be performed on the current chrominance block.

In an implementation example, the determining a predicted value of the current chrominance block in this disclosure may further include the following scheme: determining the current chrominance block in a video bitstream; partitioning the current chrominance block into P*Q chrominance sub-blocks, both P and Q being integers; obtaining a block vector of a luminance co-located sub-block corresponding to each chrominance sub-block; and determining the predicted value of the current chrominance block based on the obtained P*Q block vectors. For details of a specific process of obtaining a block vector of any chrominance sub-block, refer to the specific process of determining the target displacement vector in operation S602, and details are not described herein again. Similarly, for a specific process of determining the predicted value of the current chrominance block based on each block vector, refer to the specific process of determining the predicted value in operation S603, and details are not described herein again.

In this embodiment of this disclosure, a current chrominance block in a video bitstream may be determined, a chrominance block copy intra prediction mode being used for the current chrominance block. A target displacement vector of a luminance co-located block corresponding to the current chrominance block is obtained. A predicted value of the current chrominance block is determined based on the target displacement vector. The predicted value is configured for reconstructing a decoded picture corresponding to the current chrominance block. In view of the above, during decoding of the video bitstream, when it is determined that the chrominance block copy intra prediction mode is used for the current chrominance block, the predicted value of the current chrominance block can be determined by using the displacement vector information of the luminance co-located block, without needing to perform intra prediction processing on the current chrominance block, so that encoding/decoding efficiency of the current chrominance block is improved, thereby effectively improving coding performance.

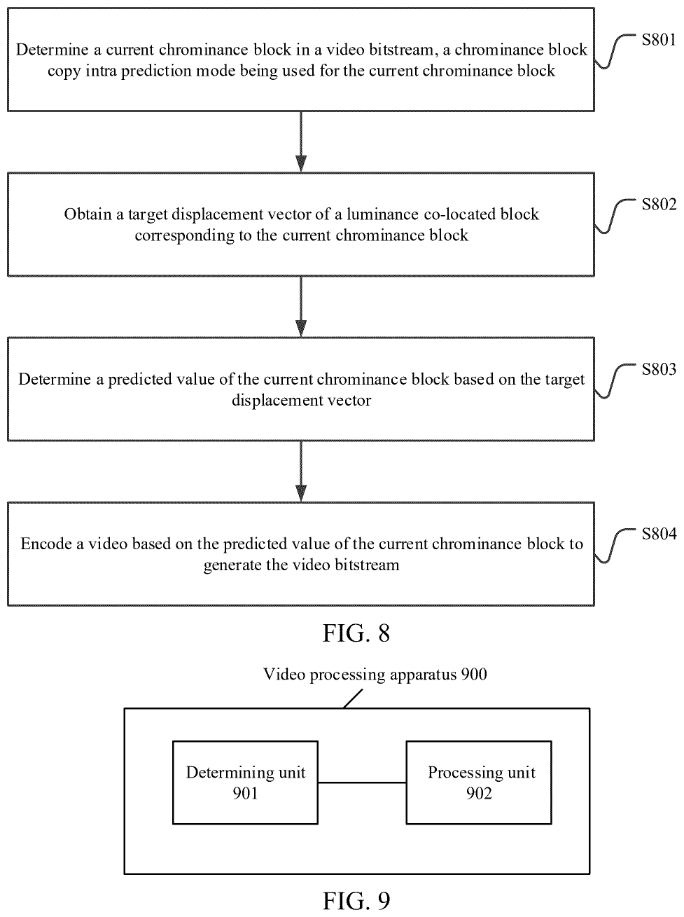

FIG. 8 is a schematic flowchart of another video processing method according to an embodiment of this disclosure. The video processing method may be performed by the encoding device in the video processing system. The video processing method described in this embodiment may include the following operations S801 to S804.

S801: Determine a current chrominance block in a video, a chrominance block copy intra prediction mode being used for the current chrominance block.

In an implementation example, whether the chrominance block copy intra prediction mode is used for the current chrominance block is indicated by mode indication information, and the mode indication information includes at least one of the following: sequence header flag, picture header flag, slice header flag, coding unit flag, implicit information, or chrominance indication information. The chrominance block copy intra prediction mode is a prediction mode independent of an ordinary intra prediction mode; or the chrominance block copy intra prediction mode is a sub-mode of an ordinary intra prediction mode; and the ordinary intra prediction mode includes at least one of the following: an intra prediction direct current mode, an angle-based intra prediction mode, a two-step cross-component prediction mode, or a prediction mode of deriving a predicted value based on an intra reference pixel.

(1) The chrominance block copy intra prediction mode is a prediction mode independent of the ordinary intra prediction mode.
(i) If the mode indication information is a sequence header flag seq_cibc_flag, when the sequence header flag seq_cibc_flag is a first preset value (for example, 1), the chrominance block copy intra prediction mode is allowed to be used for the current chrominance block, or when the sequence header flag seq_cibc_flag is a second preset value (for example, 0), the chrominance block copy intra prediction mode is not allowed to be used for the current chrominance block.
(ii) If the mode indication information is a picture header flag pic_cibc_flag, when the picture header flag pic_cibc_flag is a first preset value (for example, 1), the chrominance block copy intra prediction mode is allowed to be used for the current chrominance block, or when the picture header flag pic_cibc_flag is a second preset value (for example, 0), the chrominance block copy intra prediction mode is not allowed to be used for the current chrominance block.
(iii) If the mode indication information is a slice header flag patch_cibc_flag, when the slice header flag patch_cibc_flag is a first preset value (for example, 1), the chrominance block copy intra prediction mode is allowed to be used for the current chrominance block, or when the slice header flag patch_cibc_flag is a second preset value (for example, 0), the chrominance block copy intra prediction mode is not allowed to be used for the current chrominance block.
(iv) If the mode indication information is a coding unit flag cu_cibc_flag, when the coding unit flag cu_cibc_flag is a first preset value (for example, 1), the chrominance block copy intra prediction mode is used for the current chrominance block, or when the coding unit flag cu_cibc_flag is a second preset value (for example, 0), the chrominance block copy intra prediction mode is not used for the current chrominance block.

The foregoing operations (i) to (iv) may be used independently, or the foregoing operations 1 to 4 may be used in combination. For example, when the sequence header flag seq_cibc_flag=1, it may be determined that the chrominance block copy intra prediction mode is used for the current chrominance block in a current sequence. For another example, when the sequence header flag seq_cibc_flag=1, and the coding unit flag cu_cibc_flag=1, it may be determined that the chrominance block copy intra prediction mode is used for the current chrominance block. For still another example, when seq_cibc_flag=1, bic_cibc_flag=1, patch_cibc_flag=1, and cu_cibc_flag, it may be determined that the chrominance block copy intra prediction mode is used for the current chrominance block.

(2) The chrominance block copy intra prediction mode is a sub-mode of the ordinary intra prediction mode. In this mode, enabling or disabling of the chrominance block copy intra prediction mode is associated with the intra prediction mode (for example, IBC or ISC).
(i) If it is determined that an IBC mode or an ISC mode is enabled in a current sequence, it may be determined that the chrominance block copy intra prediction mode is allowed to be used for the current chrominance block. If it is determined that an IBC mode or an ISC mode is disabled in a current sequence, it may be determined that the chrominance block copy intra prediction mode is not allowed to be used for the current chrominance block.
(ii) If it is determined that an IBC mode or an ISC mode is enabled in a current picture, it may be determined that the chrominance block copy intra prediction mode is allowed to be used for the current chrominance block. If it is determined that an IBC mode or an ISC mode is disabled in a current picture, it may be determined that the chrominance block copy intra prediction mode is not allowed to be used for the current chrominance block.
(iii) If it is determined that an IBC mode or an ISC mode is enabled in a current slice, it may be determined that the chrominance block copy intra prediction mode is allowed to be used for the current chrominance block. If it is determined that an IBC mode or an ISC mode is disabled in a current slice, it may be determined that the chrominance block copy intra prediction mode is not allowed to be used for the current chrominance block.
(iv) If it is determined that an IBC mode or an ISC mode is enabled in a current coding unit, it may be determined that the chrominance block copy intra prediction mode is allowed to be used for the current chrominance block. If it is determined that an IBC mode or an ISC mode is disabled in a current coding unit, it may be determined that the chrominance block copy intra prediction mode is not allowed to be used for the current chrominance block.

In this embodiment of this disclosure, in addition to being represented as the chrominance block copy intra prediction mode, the prediction mode used for the current chrominance block may alternatively be represented in other different manners. For example, the prediction mode may alternatively be represented as a sub-mode of the ordinary intra prediction mode, or another prediction mode name. A specific name of the prediction mode used for the current chrominance block is not limited in this disclosure.

S802: Obtain a target displacement vector of a luminance co-located block corresponding to the current chrominance block.

The luminance co-located block corresponding to the current chrominance block is determined. In an implementation example, a position and a size of the corresponding luminance co-located block may be determined based on a position and a size of the current chrominance block and a color format of a video picture. Assuming that an upper left corner position of the current chrominance block has coordinates of (xC, yC) and a size of (wC, hC), that horizontal and vertical sampling ratios of a luminance component to a chrominance component that correspond to a color format are respectively (scaleX, scaleY), and that the color format is, for example, a YUV420 format, scaleX=2, and scaleY=2.

Next, the target displacement vector is determined from the luminance co-located block. In an implementation example, the obtaining a target displacement vector of a luminance co-located block corresponding to the current chrominance block includes: constructing a candidate displacement vector list of the luminance co-located block corresponding to the current chrominance block; and determining the target displacement vector from the candidate displacement vector list.

(1) Displacement vectors configured for constructing the candidate displacement vector list include the following.
i. A displacement vector of a luminance sample point that is in the luminance co-located block and that satisfies a specified mode. The specified mode includes: any one of an intra block copy prediction mode, an intra string copy prediction ordinary string sub-mode, an intra string copy prediction non-ordinary string sub-mode, an intra template matching mode, an inter prediction mode, an affine movement mode, an inter-intra compound mode, an angular weighted prediction (AWP) mode, a spatial angular weighted prediction (SAWP) mode, and an inter geometrical partitioning mode (GPM).
ii. A displacement vector of a spatially neighboring block corresponding to the luminance co-located block. The spatially neighboring block is a coding block adjacent to a current coding block (also referred to as a coding unit) in a current frame of a video, and the current frame is a video frame to which the current coding unit belongs. The current coding block is a coding block being decoded in the current frame.
iii. A displacement vector in an intra prediction historical motion information table (for example, an HMVP or an IntraHMVP) of the luminance co-located block.
iv. A displacement vector obtained by performing offset processing on the candidate displacement vector in operations i to iii.
v. If no valid displacement vector exists, the list may be populated with a default displacement vector. The default displacement vector includes: (−w, 0), (0, −h), (−w, −h), (−2*w, 0), (0, −2*h). Alternatively, the displacement vector in the candidate displacement vector list is set to an invalid value, for example, (0, 0).

A condition that the displacement vector in the candidate displacement vector list needs to satisfy includes at least one of the following.
i. A reference block of the luminance co-located block meets a reference range limit of the intra block copy prediction mode.
ii. A reference block of the luminance co-located block and the displacement vector both meet a reference range limit of the intra string copy prediction ordinary string sub-mode.
iii. The displacement vector does not duplicate any displacement vector in any displacement vector list other than the candidate displacement vector list. In other words, the displacement vector added to the candidate displacement vector list is unique and does not exist in another displacement vector list different from the candidate displacement vector list.

(2). The target displacement vector is determined from the candidate displacement vector list through any one of the following methods:
(i) A K^{th} displacement vector in the candidate displacement vector list is used as the target displacement vector, K being a positive integer.
(ii) The target displacement vector is determined from the candidate displacement vector list based on a displacement vector index.
(iii) A candidate displacement vector is obtained from the candidate displacement vector list, the candidate displacement vector is scaled based on a color format sampling ratio, and integer-pixel precision of the scaled displacement vector is retained, to obtain the target displacement vector.
(iv) The candidate displacement vector is obtained from the candidate displacement vector list, and a displacement vector of a luminance component is used as the target displacement vector.

For a specific process of constructing the candidate displacement vector list and a specific process of determining the target displacement vector, refer to related operations in the foregoing embodiments. Details are not described herein again in this embodiment of this disclosure.

S803: Determine a predicted value of the current chrominance block based on the target displacement vector.

In an implementation example, if the target displacement vector has integer-pixel precision, motion compensation is performed on the target displacement vector, to derive the predicted value of the current chrominance block. Alternatively, if the target displacement vector has fractional-pixel precision, interpolation is performed on the target displacement vector, and motion compensation is performed on the target displacement vector undergone the interpolation, to derive the predicted value of the current chrominance block.

In another possible implementation, if no target displacement vector exists in the luminance co-located block corresponding to the current chrominance block, the predicted value of the current chrominance block is exported by using the intra prediction mode. The intra prediction mode includes: a cross-component intra prediction mode, or a specified intra prediction mode. (1) The cross-component intra prediction mode includes: a two-step cross-component prediction mode (TSPCM), and a cross-component linear model (CCLM) prediction mode. (2) The specified intra prediction mode includes: any one or more of an intra prediction direct current (DC) mode, an intra prediction bilinear prediction mode, an intra prediction planar/plane prediction mode, a horizontal-direction intra prediction mode, and a vertical-direction intra prediction mode.

S804: Encode the video based on the predicted value of the current chrominance block to generate a video bitstream.

In an implementation example, before encoding the video based on the predicted value of the current chrominance block to generate a video bitstream, whether residual encoding needs to be performed on the current chrominance block further needs to be determined. In some examples, the following two cases are included:

(1) If residual encoding does not need to be performed on the current chrominance block, the current chrominance block is directly encoded based on the predicted value of the current chrominance block, to obtain a coding picture corresponding to the current chrominance block.

(2) If residual encoding needs to be performed on the current chrominance block, residual encoding is performed on the current chrominance block to obtain a difference, and the current chrominance block is encoded based on the difference and the predicted value of the current chrominance block, to obtain a coding picture corresponding to the current chrominance block.

The luminance co-located block corresponding to the current chrominance block includes a plurality of luminance blocks, and a condition for determining whether residual encoding needs to be performed on the current chrominance block includes any one of the following:
i. The intra string copy prediction ordinary string sub-mode is used for a target luminance sample point, and residual encoding does not need to be performed on a luminance block in which the target luminance sample point is located.
ii. An intra string copy prediction mode is used for a target luminance sample point, and residual encoding does not need to be performed on a luminance block in which the target luminance sample point is located.
iii. The intra block copy prediction mode is used for a target luminance sample point, and residual encoding does not need to be performed on a luminance block in which the target luminance sample point is located.
iv. The intra string copy prediction ordinary string sub-mode or the intra block copy prediction mode is used for a target luminance sample point, and residual encoding does not need to be performed on a luminance block in which the target luminance sample point is located.
v. An intra string copy prediction mode is used for a target luminance sample point or the intra block copy prediction mode, and residual encoding does not need to be performed on a luminance block in which the target luminance sample point is located.

In this embodiment of this disclosure, a current chrominance block in a video may be determined, a chrominance block copy intra prediction mode being used for the current chrominance block. A target displacement vector of a luminance co-located block corresponding to the current chrominance block is obtained. A predicted value of the current chrominance block is determined based on the target displacement vector. The video is encoded based on the predicted value of the current chrominance block to generate a video bitstream. In a process of encoding the video, when the chrominance block copy intra prediction mode is used for the current chrominance block, the predicted value of the current chrominance block can be determined by using the displacement vector information of the luminance co-located block, without needing to perform coding prediction processing and the like on the current chrominance block, so that decoding efficiency of the chrominance block is improved, thereby effectively improving coding performance.

The following describes relevant apparatuses in embodiments of this disclosure with reference to FIG. 9 to FIG. 11.

FIG. 9 is a schematic diagram of a structure of a video processing apparatus according to an embodiment of this disclosure. As shown in FIG. 9, the video processing apparatus 900 may be used in the computer device mentioned in the foregoing embodiment, and the computer device may be the decoding device mentioned in the foregoing method embodiment. In some examples, the video processing apparatus 900 may be a computer program (including program code) running in a computer device. For example, the video processing apparatus 900 is application software. The video processing apparatus 900 may be configured to perform corresponding operations in the video processing method provided in embodiments of this disclosure. In an implementation example, the video processing apparatus 900 may include:
a determining unit 901, configured to determine a current chrominance block in a video bitstream, a chrominance block copy intra prediction mode being used for the current chrominance block; and
a processing unit 902, configured to obtain a target displacement vector of a luminance co-located block corresponding to the current chrominance block,
the processing unit 902 being further configured to determine a predicted value of the current chrominance block based on the target displacement vector. The predicted value is configured for reconstructing a decoded picture corresponding to the current chrominance block.

In an implementation example, the chrominance block copy intra prediction mode is a prediction mode independent of an ordinary intra prediction mode; or the chrominance block copy intra prediction mode is a sub-mode of an ordinary intra prediction mode; and
the ordinary intra prediction mode includes at least one of the following: an intra prediction direct current mode, an angle-based intra prediction mode, a two-step cross-component prediction mode, or a prediction mode of deriving a predicted value based on an intra reference pixel.

In an implementation example, after the determining a current chrominance block in a video bitstream, the processing unit 902 is further configured to perform the following operations:
partitioning the current chrominance block into P*Q chrominance sub-blocks, both P and Q being integers;
obtaining a block vector of a luminance co-located sub-block corresponding to each chrominance sub-block; and
determining the predicted value of the current chrominance block based on the obtained P*Q block vectors.

In an implementation example, the processing unit 902 is further configured to perform the following operations:
decoding the video bitstream to obtain mode indication information, the mode indication information indicating whether the chrominance block copy intra prediction mode is used for the current chrominance block; and
the mode indication information including at least one of the following: sequence header flag, picture header flag, slice header flag, coding unit flag, implicit information, or chrominance indication information.

In an implementation example, if the mode indication information is the sequence header flag, the mode indication information is set in a sequence header of a current sequence to which the current chrominance block belongs, and when the sequence header flag is a first preset value, the chrominance block copy intra prediction mode is allowed to be used for the current chrominance block, or when the sequence header flag is a second preset value, the chrominance block copy intra prediction mode is not used for the current chrominance block;
if the mode indication information is a picture header flag, the mode indication information is set in a picture header of a current picture to which the current chrominance block belongs, and when the picture header flag is a first preset value, the chrominance block copy intra prediction mode is allowed to be used for the current chrominance block, or when the picture header flag is a second preset value, the chrominance block copy intra prediction mode is not used for the current chrominance block;
if the mode indication information is a slice header flag, the mode indication information is set in a slice header of a current slice to which the current chrominance block belongs, and when the slice header flag is a first preset value, the chrominance block copy intra prediction mode is allowed to be used for the current chrominance block, or when the slice header flag is a second preset value, the chrominance block copy intra prediction mode is not used for the current chrominance block;
if the mode indication information is a coding unit flag, the mode indication information is set in a current coding unit, and when the coding unit flag is a first preset value, the chrominance block copy intra prediction mode is used for the current chrominance block, or when the coding unit flag is a second preset value, the chrominance block copy intra prediction mode is not used for the current chrominance block;
if the mode indication information is implicit information, when the implicit information indicates that a luminance sample point at a preset position within the luminance co-located block corresponding to the current chrominance block satisfies a preset condition, the chrominance block copy intra prediction mode is used for the current chrominance block; or
if the mode indication information is the chrominance indication information, when the chrominance indication information indicates that a preset intra prediction mode is used for the current chrominance block and a luminance sample point at a preset position within the luminance co-located block satisfies a preset condition, the chrominance block copy intra prediction mode is used for the current chrominance block, and the preset intra prediction mode includes an inherited mode.

In an implementation example, the processing unit 902 is further configured to perform the following operations:
checking whether the video bitstream satisfies a decoding condition; and
decoding, if the video bitstream satisfies the decoding condition, the video bitstream to obtain the mode indication information.

In an implementation example, the decoding condition includes: A color format of the video bitstream is a format including a chrominance component.

When the mode indication information is set in a current coding unit to which the current chrominance block belongs, the decoding condition includes any one or more of the following.

The current coding unit only includes the chrominance component.

The luminance sample point at the preset position within the luminance co-located block corresponding to the current chrominance block satisfies the preset condition.

If a plurality of preset positions exist, a quantity of luminance sample points satisfying the preset condition is at least one, or is greater than or equal to a preset threshold.

In an implementation example, the preset position may be determined through any one of the following methods:
determining a preset chrominance sample point within the current chrominance block, and determining, based on a position of the preset chrominance sample point, the preset position of the corresponding luminance sample point within the luminance co-located block;
determining the preset position within the luminance co-located block;
determining, based on a partitioning mode of the luminance co-located block, the preset position within each sub-block obtained by partitioning the luminance co-located block; or
partitioning the luminance co-located block into M*N sub-blocks, and using specified positions within the M*N sub-blocks as the preset positions, the specified position including: any one of a center, an upper left corner, an upper right corner, a lower left corner, and a lower right corner of a sub-block, and M and N being positive integers.

In an implementation example, the preset condition includes any one or more of the following:
The luminance sample point uses any mode in a particular mode set, the particular mode set including: any one or more of an intra block copy prediction mode, an intra string copy prediction ordinary string sub-mode, an intra string copy prediction non-ordinary string sub-mode, or another prediction mode with an intra displacement vector;
the luminance sample point has a valid displacement vector; and
an intra prediction historical motion information table of the current chrominance block is not empty.

In an implementation example, that the processing unit 902 obtains the target displacement vector of the luminance co-located block corresponding to the current chrominance block is configured for performing the following operations:
constructing a candidate displacement vector list of the luminance co-located block corresponding to the current chrominance block; and
determining the target displacement vector from the candidate displacement vector list.

In an implementation example, the processing unit 902 constructs the candidate displacement vector list of the luminance co-located block corresponding to the current chrominance block through any one or more of the following methods:
adding, to the candidate displacement vector list, a displacement vector of a luminance sample point that is in the luminance co-located block and that satisfies a specified mode, the specified mode including: any one of an intra block copy prediction mode, an intra string copy prediction ordinary string sub-mode, a string copy intra prediction non-ordinary string sub-mode, an intra template matching mode, an inter prediction mode, an affine movement mode, an inter-intra compound mode, and an angular weighted prediction mode;
adding, to the candidate displacement vector list, a displacement vector of a spatially neighboring block corresponding to the luminance co-located block;
adding, to the candidate displacement vector list, a displacement vector in a historical motion information table or in an intra prediction historical motion information table;
performing offset processing on a candidate displacement vector and then adding the candidate displacement vector to the candidate displacement vector list, the candidate displacement vectors including: any one or more of the displacement vector of the luminance sample point that is in the luminance co-located block and that satisfies the specified mode, and the displacement vector of the spatially neighboring block corresponding to the luminance co-located block; or
if no valid displacement vector exists in the luminance co-located block, adding a default displacement vector to the candidate displacement vector list, or setting a displacement vector in the candidate displacement vector list to an invalid value.

In an implementation example, a condition that the displacement vector in the candidate displacement vector list needs to satisfy includes at least one of the following:
a reference block of the luminance co-located block meets a reference range limit of the intra block copy prediction mode;
a reference block of the luminance co-located block and the displacement vector both meet a reference range limit of the intra string copy prediction ordinary string sub-mode;
the displacement vector does not duplicate any displacement vector other than that in the candidate displacement vector list; or
the displacement vector does not duplicate the first N or the last N displacement vectors in the candidate displacement vector list, and N is an integer.

In an implementation example, a sorting manner of displacement vectors in the candidate displacement vector list includes any one of the following:
sorting based on a preset sequence;
sorting based on costs of the displacement vectors, the costs including at least: a rate-distortion cost, a sum of absolute differences, a sum of absolute transformed differences, a sum of squared errors, a mean-removed sum of absolute differences, and a mean-removed sum of squared errors;
sorting based on types of the displacement vectors, the types of the displacement vectors including at least: block vector, string vector, motion vector, and default vector; or
sorting based on both types of the displacement vectors and costs of the displacement vectors in a combined manner.

In an implementation example, the processing unit 902 determines the target displacement vector from the candidate displacement vector list through any one of the following methods:
using a K^{th} displacement vector in the candidate displacement vector list as the target displacement vector, K being a positive integer;
determining the target displacement vector from the candidate displacement vector list based on a displacement vector index;
obtaining a candidate displacement vector from the candidate displacement vector list, scaling the candidate displacement vector based on a color format sampling ratio, and retaining integer-pixel precision of the scaled displacement vector, to obtain the target displacement vector; or
obtaining a candidate displacement vector from the candidate displacement vector list, and using the candidate displacement vector as the target displacement vector.

In an implementation example, that the processing unit 902 determines the predicted value of the current chrominance block based on the target displacement vector is configured for performing the following operations:
performing, if the target displacement vector has integer-pixel precision, motion compensation on the target displacement vector, to derive the predicted value of the current chrominance block; or
performing, if the target displacement vector has fractional-pixel precision, interpolation on the target displacement vector, and performing motion compensation on the target displacement vector undergone the interpolation, to derive the predicted value of the current chrominance block.

In an implementation example, the processing unit 902 is further configured to perform the following operations:
exporting, if no target displacement vector exists in the luminance co-located block corresponding to the current chrominance block, the predicted value of the current chrominance block by using the intra prediction mode,
the intra prediction mode including: a cross-component intra prediction mode, or a specified intra prediction mode; the cross-component intra prediction mode including: a two-step cross-component prediction mode and a cross-component linear model prediction mode; and the specified intra prediction mode including: any one or more of an intra prediction direct current mode, an intra prediction bilinear prediction mode, an intra prediction planar/plane prediction mode, a horizontal-direction intra prediction mode, and a vertical-direction intra prediction mode.

In an implementation example, the processing unit 902 is further configured to perform the following operations:
determining, based on information about a target luminance sample point within the luminance co-located block corresponding to the current chrominance block, if the chrominance block copy intra prediction mode is used for the current chrominance block, whether residual decoding needs to be performed on the current chrominance block, the target luminance sample point being a luminance sample point corresponding to the target displacement vector;
performing, if it is determined that residual decoding needs to be performed on the current chrominance block, the residual decoding on the current chrominance block to obtain a difference; and
reconstructing a decoded picture corresponding to the current chrominance block based on the difference and the predicted value of the current chrominance block.

In an implementation example, the luminance co-located block corresponding to the current chrominance block includes a plurality of luminance blocks. A condition for determining that residual decoding does not need to be performed on the current chrominance block includes any one of the following:
the intra string copy prediction ordinary string sub-mode is used for the target luminance sample point, and residual encoding does not need to be performed on a luminance block in which the target luminance sample point is located;
an intra string copy prediction mode is used for the target luminance sample point, and residual encoding does not need to be performed on a luminance block in which the target luminance sample point is located;
the intra block copy prediction mode is used for the target luminance sample point, and residual encoding does not need to be performed on a luminance block in which the target luminance sample point is located;
the intra string copy prediction ordinary string sub-mode or the intra block copy prediction mode is used for the target luminance sample point, and residual encoding does not need to be performed on a luminance block in which the target luminance sample point is located; or
an intra string copy prediction mode or the intra block copy prediction mode is used for the target luminance sample point, and residual encoding does not need to be performed on a luminance block in which the target luminance sample point is located,
a condition for determining whether residual encoding needs to be performed on the luminance block in which the target luminance sample point is located is determined based on: a coefficient flag of the luminance block or a prediction mode of the current chrominance block.

In this embodiment of this disclosure, for specific implementation of operations performed by the units of the video processing apparatus and corresponding effects that can be generated, refer to related descriptions of the foregoing embodiments. Details are not described herein again.

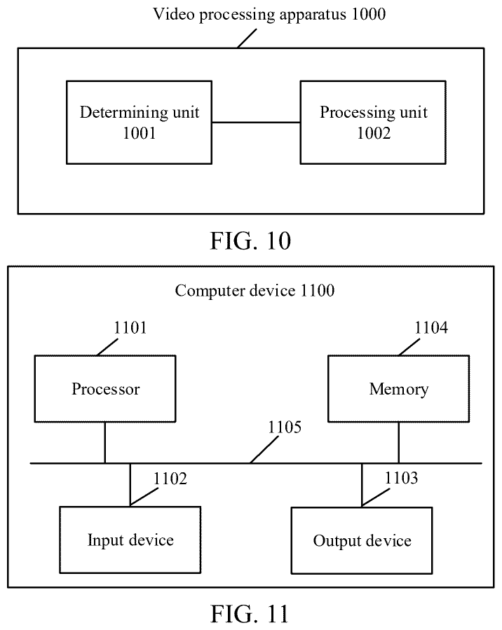

FIG. 10 is a schematic diagram of a structure of another video processing apparatus according to an embodiment of this disclosure. As shown in FIG. 10, the video processing apparatus 1000 may be used in the computer device mentioned in the foregoing embodiment, and the computer device may be the encoding device mentioned in the foregoing method embodiment. In some examples, the video processing apparatus 1000 may be a computer program (including program code) running in a computer device. For example, the video processing apparatus 1000 is application software. The video processing apparatus 1000 may be configured to perform corresponding operations in the video processing method provided in embodiments of this disclosure. In an implementation example, the video processing apparatus 1000 may include:
a determining unit 1001, configured to determine a current chrominance block in a video, a chrominance block copy intra prediction mode being used for the current chrominance block; and
a processing unit 1002, configured to obtain a target displacement vector of a luminance co-located block corresponding to the current chrominance block,
the processing unit 1002 being further configured to determine a predicted value of the current chrominance block based on the target displacement vector. The predicted value is configured for reconstructing a decoded picture corresponding to the current chrominance block.
the processing unit 1002 being further configured to encode the video based on the predicted value of the current chrominance block to generate a video bitstream.

In this embodiment of this disclosure, for specific implementation of operations performed by the units of the video processing apparatus and corresponding effects that can be generated, refer to related descriptions of the foregoing embodiments. Details are not described herein again.

FIG. 11 is a schematic diagram of a structure of a computer device according to an embodiment of this disclosure. As shown in FIG. 11, the computer device 1100 may include: a processor 1101, an input device 1102, an output device 1103, and a memory 1104. The processor 1101, the input device 1102, the output device 1103, and the memory 1104 are connected through a bus 1105. The memory 1104 is configured to store a computer program, the computer program includes program instructions, and the processor 1101 is configured to execute the program instructions stored in the memory 1104. In some examples, the processor 1101 runs the program instructions in the memory 1104, so that the computer device performs the method operations in the foregoing embodiments of this disclosure. In addition, after the computer device performs the method operations in the embodiments by using the processor, for an achieved effect, refer to descriptions in the foregoing embodiments, and details are not described herein again.

According to an aspect of this disclosure, this embodiment of this disclosure further provides a computer-readable storage medium, having a computer program stored thereon, and the computer program includes program instructions. When the program instructions are executed by a processor, the methods in the embodiments corresponding to FIG. 5 and FIG. 9 can be executed, and therefore details are not described herein again. For technical details that are not disclosed in the embodiments of the computer-readable storage medium included in this disclosure, reference may be made to the descriptions about the method embodiments of this disclosure. As an example, the program instructions may be deployed to be executed on a computer device, or deployed to be executed on a plurality of computer devices at the same position, or deployed to be executed on a plurality of computer devices that are distributed in a plurality of positions and interconnected through a communication network.

According to an aspect of this disclosure, this embodiment of this disclosure further provides a computer program product. The computer program product includes a computer program. The computer program is stored in a computer-readable storage medium. A processor of a computer device reads the computer program from the computer-readable storage medium, and the processor executes the computer program, so that the computer device can perform the method in the foregoing embodiment, and therefore details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of video processing, comprising:
determining that a current chrominance block in a current picture carried in a video bitstream is coded in a chrominance block copy intra prediction mode that predicts at least a value of the current chrominance block based on a displacement vector;
obtaining a target displacement vector of a co-located luminance block of the current chrominance block, the target displacement vector being selected from a plurality of candidate displacement vectors associated with the co-located luminance block of the current chrominance block;
determining at least a predicted value of the current chrominance block based on the target displacement vector; and
reconstructing the current picture that includes the current chrominance block based on at least the predicted value.

2. The method according to claim 1, wherein:
the chrominance block copy intra prediction mode is a different prediction mode from an ordinary intra prediction mode; and
the ordinary intra prediction mode comprises at least one of: an intra prediction direct current mode, an angle-based intra prediction mode, a two-step cross-component prediction mode, or a prediction mode of deriving a predicted value based on an intra reference pixel.

3. The method according to claim 1, wherein:
the chrominance block copy intra prediction mode is a sub-mode of an ordinary intra prediction mode; and
the ordinary intra prediction mode comprises at least one of: an intra prediction direct current mode, an angle-based intra prediction mode, a two-step cross-component prediction mode, or a prediction mode of deriving a predicted value based on an intra reference pixel.

4. The method according to claim 1, the method further comprising:
partitioning the current chrominance block into P*Q chrominance sub-blocks, both P and Q being integers;
obtaining respective block vectors of co-located luminance sub-blocks corresponding to the P*Q chrominance sub-blocks; and
determining predicted values of the current chrominance block based on the respective block vectors.

5. The method according to claim 1, the method further comprising:
decoding the video bitstream to obtain mode indication information, the mode indication information indicating whether the chrominance block copy intra prediction mode is used for the current chrominance block; and
the mode indication information comprising at least one: sequence header flag, picture header flag, slice header flag, coding unit flag, implicit information, or chrominance indication information.

6. The method according to claim 5, wherein:
when the mode indication information is a sequence header flag in a sequence header of a current sequence that includes the current chrominance block, a first preset value of the sequence header flag indicating that the chrominance block copy intra prediction mode is allowed for the current chrominance block, a second preset value of the sequence header flag indicating that the chrominance block copy intra prediction mode is not used for the current chrominance block;
when the mode indication information is a picture header flag in a picture header of a current picture that includes the current chrominance block, a first preset value of the picture header flag indicating that the chrominance block copy intra prediction mode is allowed for the current chrominance block, a second preset value of the picture header flag indicating that the chrominance block copy intra prediction mode is not used for the current chrominance block;
when the mode indication information is a slice header flag in a slice header of a current slice that includes the current chrominance block, a first preset value of the slice header flag indicating that the chrominance block copy intra prediction mode is allowed for the current chrominance block, a second preset value of the slice header flag indicating that the chrominance block copy intra prediction mode is not used for the current chrominance block;
when the mode indication information is a coding unit flag of a current coding unit that includes the current chrominance block, a first preset value of the coding unit flag indicating that the chrominance block copy intra prediction mode is used for the current chrominance block, a second preset value of the coding unit flag indicating that the chrominance block copy intra prediction mode is not used for the current chrominance block;
when the mode indication information is implicit information, and the implicit information indicates that a luminance sample point at a preset position within the co-located luminance block of the current chrominance block satisfies a preset condition, the chrominance block copy intra prediction mode is used for the current chrominance block; or
when the mode indication information is chrominance indication information, and the chrominance indication information indicates that a preset intra prediction mode is used for the current chrominance block and a luminance sample point at a preset position within the co-located luminance block satisfies a preset condition, the chrominance block copy intra prediction mode is used for the current chrominance block.

7. The method according to claim 5, the method further comprising:
checking whether the video bitstream satisfies a decoding condition; and
decoding, when the video bitstream satisfies the decoding condition, the video bitstream to obtain the mode indication information.

8. The method according to claim 7, wherein:
a color format of the video bitstream comprises a chrominance component; and
when the mode indication information is set in a current coding unit includes the current chrominance block, the decoding condition comprises at least one of:
the current coding unit comprises only the chrominance component;
a luminance sample point at a preset position within the co-located luminance block of the current chrominance block satisfies a preset condition; or
a quantity of luminance sample points at a plurality of preset positions satisfying the preset condition is at least one, or is greater than or equal to a preset threshold.

9. The method according to claim 8, wherein the preset position of the luminance sample point includes at least one of:
a position of a luminance sample point corresponding to a preset chrominance sample point within the current chrominance block;
a preset position within the co-located luminance block;
respective preset positions within sub-blocks of the co-located luminance block; or
respective specified positions within M*N sub-blocks of the co-located luminance block, a specified position within a subblock of the M*N sub-blocks comprising at least one of: a center, an upper left corner, an upper right corner, a lower left corner, or a lower right corner of the sub-block, and M and N being positive integers.

10. The method according to claim 8, wherein the preset condition comprises one or more of:
the luminance sample point being coded by one or more of an intra block copy prediction mode, an intra string copy prediction ordinary string sub-mode, an intra string copy prediction non-ordinary string sub-mode, or a prediction mode with an intra displacement vector;
the luminance sample point having a valid displacement vector; and
an intra prediction historical motion information table of the current chrominance block not being empty.

11. The method according to claim 1, wherein the obtaining the target displacement vector comprises:
constructing a candidate displacement vector list for the co-located luminance block, the candidate displacement vector list comprising the plurality of candidate displacement vectors associated with the co-located luminance block; and
determining the target displacement vector from the candidate displacement vector list.

12. The method according to claim 11, wherein the constructing the candidate displacement vector list comprises at least one of:
adding, to the candidate displacement vector list, a first displacement vector of a first luminance sample point in the co-located luminance block when the first luminance sample point is coded with a specified mode, the specified mode comprising: one of an intra block copy prediction mode, an intra string copy prediction ordinary string sub-mode, a string copy intra prediction non-ordinary string sub-mode, an intra template matching mode, an inter prediction mode, an affine movement mode, an inter-intra compound mode, and an angular weighted prediction mode;
adding, to the candidate displacement vector list, a second displacement vector of a spatially neighboring block of the co-located luminance block;
adding, to the candidate displacement vector list, a third displacement vector from a historical motion information table or from an intra prediction historical motion information table;
adding a fourth displacement vector that is a combination of an existing candidate displacement vector in the candidate displacement vector list and an offset,
adding a default displacement vector when no valid displacement vector exists in the co-located luminance block, or
setting a displacement vector in the candidate displacement vector list to an invalid value when no valid displacement vector exists in the co-located luminance block.

13. The method according to claim 11, wherein a candidate displacement vector in the candidate displacement vector list satisfies at least one of:
a reference block of the co-located luminance block according to the candidate displacement vector meeting a reference range limit of an intra block copy prediction mode;
a reference block of the co-located luminance block according to the candidate displacement vector and the candidate displacement vector meeting respective reference range limits of an intra string copy prediction ordinary string sub-mode;
the candidate displacement vector not being a duplicate to other candidate displacement vectors in the candidate displacement vector list; or
the candidate displacement vector not being a duplicate to first N or last N candidate displacement vectors in the candidate displacement vector list, and N being a positive integer.

14. The method according to claim 11, further comprising at least one of:
sorting the plurality of candidate displacement vectors based on a preset sequence;
sorting the plurality of candidate displacement vectors based on respective costs associated with the plurality of candidate displacement vectors, a cost associated with a candidate displacement vector in the plurality of candidate displacement vectors comprising at least one of:
a rate-distortion cost, a sum of absolute differences, a sum of absolute transformed differences, a sum of squared errors, a mean-removed sum of absolute differences, and a mean-removed sum of squared errors;
sorting the plurality of candidate displacement vectors based on respective types of the plurality of candidate displacement vectors, a type of a candidate displacement vector in the plurality of candidate displacement vectors comprising at least one of: a block vector type, a string vector type, a motion vector type, and a default vector type; or
sorting the plurality of candidate displacement vectors based on a combination of the respective types of the plurality of candidate displacement vectors and the respective costs of the plurality of candidate displacement vectors.

15. The method according to claim 11, wherein the determining the target displacement vector comprises at least one of:
using a K^{th} candidate displacement vector in the candidate displacement vector list as the target displacement vector, K being a positive integer;
determining the target displacement vector from the candidate displacement vector list based on a displacement vector index;
scaling a candidate displacement vector in the candidate displacement vector list based on a color format sampling ratio to obtain a scaled displacement vector, the target displacement vector corresponding to integer pixel precision of the scaled displacement vector; or
using a candidate displacement vector in the candidate displacement vector list as the target displacement vector.

16. The method according to claim 1, the method further comprising:
deriving, when no target displacement vector exists, a predicted value of the current chrominance block by using an intra prediction mode,
wherein the intra prediction mode comprises at least one of: a two-step cross-component prediction mode, a cross-component linear model prediction mode, an intra prediction direct current mode, an intra prediction bilinear prediction mode, an intra prediction planar/plane prediction mode, a horizontal-direction intra prediction mode, and a vertical-direction intra prediction mode.

17. The method according to claim 1, the method further comprising:
determining whether to perform a residual decoding on the current chrominance block;
performing, when to perform the residual decoding on the current chrominance block is determined, the residual decoding on the current chrominance block to obtain a difference; and
reconstructing the current picture that includes the current chrominance block based on the difference and the predicted value of the current chrominance block.

18. The method according to claim 17, wherein:
the determining whether to perform the residual decoding comprises at least one of:
determining not to perform the residual decoding when an intra string copy prediction ordinary string sub-mode is used for coding a target luminance sample point in the co-located luminance block, and no residual encoding is performed on a luminance block that includes the target luminance sample point;
determining not to perform the residual decoding when an intra string copy prediction mode is used for coding a target luminance sample point in the co-located luminance block, and no residual encoding is performed on a luminance block that includes the target luminance sample point;
determining not to perform the residual decoding when an intra block copy prediction mode is used for a target luminance sample point in the co-located luminance block, and no residual encoding is performed on a luminance block that includes the target luminance sample point is located;
determining not to perform the residual decoding when the intra string copy prediction ordinary string sub-mode or the intra block copy prediction mode is used for a target luminance sample point, and no residual encoding is performed on a luminance block that includes the target luminance sample point; or
determining not to perform the residual decoding when an intra string copy prediction mode or the intra block copy prediction mode is used for a target luminance sample point, and no residual encoding is performed on a luminance block that includes the target luminance sample point.

19. A method of video processing in an encoder, comprising:
determining to code a current chrominance block in a video by using a chrominance block copy intra prediction mode that predicts at least a value of the current chrominance block based on a displacement vector;
obtaining a target displacement vector of a co-located luminance block of the current chrominance block, the target displacement vector being selected from a plurality of candidate displacement vectors associated with the co-located luminance block of the current chrominance block;
determining at least a predicted value of the current chrominance block based on the target displacement vector; and
encoding the video based on at least the predicted value of the current chrominance block to generate a video bitstream.

20. An apparatus of video processing, comprising processing circuitry configured to:
determine that a current chrominance block in a current picture carried in a video bitstream is coded in a chrominance block copy intra prediction mode that predicts at least a value of the current chrominance block based on a displacement vector;
obtain a target displacement vector of a co-located luminance block of the current chrominance block, the target displacement vector being selected from a plurality of candidate displacement vectors associated with the co-located luminance block of the current chrominance block;
determine at least a predicted value of the current chrominance block based on the target displacement vector; and
reconstruct the current picture that includes the current chrominance block based on at least the predicted value.
